(19) United States
(12) Patent Application Publication
(10) Pub. No.: US 2026/0027732 A1
(43) Pub. Date: Jan. 29, 2026

(54) MECHANICAL MANIPULATION SYSTEM FOR EXECUTING AUTHENTICATION PROCESS, AND COMPUTER PROGRAM

(71) Applicant: FANUC CORPORATION, Yamanashi (JP)

(72) Inventor: Gou INABA, Yamanashi (JP)

(21) Appl. No.: 18/869,842

(22) PCT Filed: Jun. 30, 2022
(86) PCT No.: PCT/JP2022/026357

§ 371 Date: Nov. 27, 2024

(51) Int. Cl. B25J 13/00; B25J 9/16; G05B 19/42

(52) U.S. Cl. CPC B25J 13/006; B25J 9/1656; G05B 19/42

(57) ABSTRACT

This mechanical manipulation system comprises: a wireless manipulation device that is connected to a control device of a robot or an industrial machine via wireless communication and that, in accordance with manipulation content, commands the control device to operate the robot or the industrial machine; and a wired manipulation device that is connected to the control device via wired communication and that has a contactless authentication tag. The wireless manipulation device has: an event detection unit that detects an approach event, in which the contactless authentication tag enters a pre-established first region from outside of the first region, and a distancing event, in which the contactless authentication tag exits the first region; and an authentication unit that, in accordance with content in the detected event, determines whether or not the manipulation content for the wireless manipulation device is valid.

### TECHNICAL FIELD

The present invention relates to a machine operation system and a computer program for executing authentication processing.

### BACKGROUND ART

In order to perform a manual operation on a robot or an industrial machine, a teaching operation device referred to as a teaching pendant connected to a controller of the robot or the industrial machine is used. A worker can perform registration, editing, condition setting, and state display of a motion program related to the robot or the industrial machine, teaching of the robot or the industrial machine, a manual operation, and the like by using the teaching operation device. In the teaching operation device, a safety switch such as an enable switch and an emergency stop button is provided in order to avoid an unexpected motion of a robot or a machine tool and secure safety of a machine and a worker around the robot or the machine tool.

Further, in recent years, a teaching operation device that performs a manual operation on a robot and an industrial machine by a general-purpose information terminal such as a tablet is used instead of hardware dedicated to the teaching operation device in terms of cost reduction, securing of versatility, and the like, and a safety switch also needs to be provided in such a teaching operation device.

For example, a robot control system has been known that includes a controller that controls a machine, a portable wireless operation panel that can perform wireless communication with the controller and is used to operate the machine, a distance measurement unit configured to measure a distance between the machine and the portable wireless operation panel, and an alarm issuing unit configured to issue an alarm to a worker or stop the machine when the distance between the machine and the portable wireless operation panel exceeds a predetermined threshold (for example, see PTL 1).

For example, a robot system has been known that includes: a robot; an RF tag including a detection device that detects biometric authentication information of a person, a memory that stores unique biometric authentication information of a qualified person permitted to perform an operation related to work of the robot, a first processor that acquires a biometric authentication result by comparing the biometric authentication information detected by the detection device with the unique biometric authentication information stored in the memory, and a first antenna that transmits the biometric authentication result acquired by the first processor; and a controller that includes a second antenna that receives the biometric authentication result transmitted from the RF tag, and progresses processing of the operation when the biometric authentication result indicates that the person is the qualified person (for example, see PTL 2).

For example, a robot control system has been known that includes a robot, a safety guard fence surrounding a motion region of the robot, a robot controller that controls a motion of the robot, and a teaching device that includes a communication means for communicating with the robot controller and transmits a motion command in response to an operation of a worker to the robot controller, and the teaching device includes a storage means for reading or writing information in a non-contact manner, and a first access means for writing and reading information to and from the storage means, an entrance of the safety guard fence is provided with a passage detection device including a detection means for detecting an access of a worker and a second access means for writing a detection result of the detection means to the storage means and reading information written to the storage means, and the teaching device validates or invalidates a motion command and motion mode switching, based on the detection result stored in the storage means, when a worker performs an operation input on the teaching device (for example, see PTL 3).

### CITATION LIST

### Patent Literature [PTL 1] JP 2016-172303A. [PTL 2] JP 2018-176300A. [PTL 3] JP 2009-262257A.

### SUMMARY OF INVENTION

### Technical Problem

In a machine operation system as a teaching operation device using a general-purpose information terminal, a base member provided with a safety switch is attached to the general-purpose information terminal. The general-purpose information terminal is connected to a controller of a robot or an industrial machine via wireless communication, but, in general, the base member is connected to the controller of the robot or the industrial machine via wired communication and secures safety. However, the general-purpose information terminal and the base member are removably attached, and thus, when the general-purpose information terminal and the base member are detached from each other and located at different places, there is a possibility that a teaching worker with the general-purpose information terminal cannot operate the safety switch with his/her own will or the safety switch may be operated by a third person different from the teaching worker, and safety cannot be secured. It is conceivable to secure safety by installing various sensors such as an optical sensor and a magnetic sensor in each of the general-purpose information terminal and the base member and detecting connection between the general-purpose information terminal and the base member, but installation of the sensors causes an increase in cost and size. Therefore, in a machine operation system formed of a general-purpose information terminal and a base member including a safety switch, the machine operation system that can secure safety at a low cost is desired.

### Solution to Problem

According to one aspect of the present disclosure, a machine operation system includes: a wireless operation device that is connected to a controller of a robot or an industrial machine via wireless communication, and commands a motion of the robot or the industrial machine to the controller in response to an operation content; and a wired operation device that is connected to the controller via wired communication, and includes a non-contact authentication tag, wherein the wireless operation device includes an event detection unit configured to detect an approach event in which the non-contact authentication tag enters the inside of a predefined first region of the wireless operation device from the outside of the first region, and a withdrawal event in which the non-contact authentication tag exits the inside of the first region to the outside of the first region, and an authentication unit configured to determine whether an operation content for the wireless operation device is valid or invalid in response to a content of an event detected by the event detection unit.

Further, according to another one aspect of the present disclosure, a machine operation system includes: a controller of a robot or an industrial machine; a wireless operation device that is connected to the controller via wireless communication, and commands a motion of the robot or the industrial machine to the controller in response to an operation content; and a wired operation device that is connected to the controller via wired communication, and includes a non-contact authentication tag to which an individual identifier is assigned, wherein the wireless operation device includes an event detection unit configured to detect an approach event in which the non-contact authentication tag enters the inside of a predefined first region of the wireless operation device from the outside of the first region, an identifier acquisition unit configured to acquire the identifier of the non-contact authentication tag when the approach event is detected by the event detection unit, an identifier writing unit configured to write, as a reference identifier, the identifier of the non-contact authentication tag acquired by the identifier acquisition unit in a setting mode to a storage unit of the controller via wireless communication, and an identifier reading unit configured to read the reference identifier from the storage unit of the controller via wireless communication when the approach event is detected by the event detection unit in an operation mode after the setting mode, and the controller includes an authentication unit configured to validate an operation content for the wireless operation device when the identifier acquired by the identifier acquisition unit coincides with the reference identifier in the operation mode.

Further, according to another one aspect of the present disclosure, a computer program is a computer program for causing a computer to execute authentication processing in a machine operation system including a wireless operation device that is connected to a controller of a robot or an industrial machine via wireless communication, and commands a motion of the robot or the industrial machine to the controller in response to an operation content, and a wired operation device that is connected to the controller via wired communication, and includes a non-contact authentication tag, and the computer program includes: an event detection step of detecting an approach event in which the non-contact authentication tag enters the inside of a predefined first region of the wireless operation device from the outside of the first region, and a withdrawal event in which the non-contact authentication tag exits the inside of the first region to the outside of the first region; and an authentication step of determining whether an operation content for the wireless operation device is valid or invalid in response to a content of an event detected in the event detection step.

Further, according to another one aspect of the present disclosure, a computer program is a computer program for causing a computer to execute authentication processing in a machine operation system including a controller of a robot or an industrial machine, a wireless operation device that is connected to the controller via wireless communication, and commands a motion of the robot or the industrial machine to the controller in response to an operation content, and a wired operation device that is connected to the controller via wired communication, and includes a non-contact authentication tag to which an individual identifier is assigned, and the computer program includes: an event detection step of detecting an approach event in which the non-contact authentication tag enters the inside of a predefined first region of the wireless operation device from the outside of the first region; an identifier acquisition step of acquiring the identifier of the non-contact authentication tag when the approach event is detected in the event detection step; an identifier writing step of setting, as a reference identifier, the identifier of the non-contact authentication tag acquired in the identifier acquisition step in a setting mode, and writing the reference identifier to a storage unit of the controller via wireless communication; an identifier reading step of reading the reference identifier from the storage unit of the controller via wireless communication when the approach event is detected in the event detection step in an operation mode after the setting mode; and an authentication step of causing the controller to execute processing of validating an operation content for the wireless operation device when the identifier acquired in the identifier acquisition step coincides with the reference identifier acquired in the identifier reading step in the operation mode.

Further, according to another one aspect of the present disclosure, a machine operation system includes: a wireless operation device that is connected to a controller of a robot or an industrial machine via wireless communication, and commands a motion of the robot or the industrial machine to the controller in response to an operation content; and a wired operation device that is connected to the controller via wired communication, and includes a non-contact authentication tag, wherein the wireless operation device includes a tag detection unit configured to detect the non-contact authentication tag, and an authentication unit configured to validate an operation content for the wireless operation device when the non-contact authentication tag is detected in the tag detection step.

Further, according to another one aspect of the present disclosure, a computer program is a computer program for causing a computer to execute authentication processing in a machine operation system including a wireless operation device that is connected to a controller of a robot or an industrial machine via wireless communication, and commands a motion of the robot or the industrial machine to the controller in response to an operation content, and a wired operation device that is connected to the controller via wired communication, and includes a non-contact authentication tag, and the computer program includes: a tag detection step of detecting the non-contact authentication tag; and an authentication step of validating an operation content for the wireless operation device when the non-contact authentication tag is detected in the tag detection step.

Further, according to another one aspect of the present disclosure, a machine operation system includes: a controller of a robot or an industrial machine; a wireless operation device that is connected to the controller via wireless communication, and commands a motion of the robot or the industrial machine to the controller in response to an operation content; and a wired operation device that is connected to the controller via wired communication, and includes a non-contact authentication tag to which an individual identifier is assigned, wherein the wireless operation device includes a tag detection unit configured to detect the non-contact authentication tag, an identifier acquisition unit configured to acquire the identifier of the non-contact authentication tag when the non-contact authentication tag is detected by the tag detection unit, an identifier writing unit configured to set, as a reference identifier, the identifier of the non-contact authentication tag acquired by the identifier acquisition unit in a setting mode, and write the reference identifier to a storage unit of the controller via wireless communication, and an identifier reading unit configured to read the reference identifier from the storage unit of the controller via wireless communication when the non-contact authentication tag is detected by the tag detection unit in an operation mode after the setting mode, and the controller includes an authentication unit configured to validate an operation content for the wireless operation device when the identifier acquired by the identifier acquisition unit coincides with the reference identifier in the operation mode.

Further, according to another one aspect of the present disclosure, a computer program is a computer program for causing a computer to execute authentication processing in a machine operation system including a controller of a robot or an industrial machine, a wireless operation device that is connected to the controller via wireless communication, and commands a motion of the robot or the industrial machine to the controller in response to an operation content, and a wired operation device that is connected to the controller via wired communication, and includes a non-contact authentication tag to which an individual identifier is assigned, and the computer program includes: a tag detection step of detecting the non-contact authentication tag; an identifier acquisition step of acquiring the identifier of the non-contact authentication tag when the non-contact authentication tag is detected in the tag detection step; an identifier writing step of setting, as a reference identifier, the identifier of the non-contact authentication tag acquired in the identifier acquisition step in a setting mode, and writing the reference identifier to a storage unit of the controller via wireless communication; an identifier reading step of reading the reference identifier from the storage unit of the controller via wireless communication when the non-contact authentication tag is detected in the tag detection step in an operation mode after the setting mode; and an authentication step of causing the controller to execute processing of validating an operation content for the wireless operation device when the identifier acquired in the identifier acquisition step coincides with the reference identifier acquired in the identifier reading step in the operation mode.

### Advantageous Effects of Invention

According to one aspect of the present disclosure, safety can be secured at a low cost in a machine operation system formed of a general-purpose information terminal and a base member including a safety switch.

### BRIEF DESCRIPTION OF DRAWINGS

FIG. 1 is a diagram illustrating a machine operation system according to first to third embodiments of the present disclosure.

FIG. 2 is a flowchart illustrating a motion flow of the machine operation system according to the first embodiment of the present disclosure.

FIG. 3 is a diagram illustrating a first specific example of a motion of the machine operation system according to the first embodiment of the present disclosure.

FIG. 4 is a diagram illustrating a second specific example of a motion of the machine operation system according to the first embodiment of the present disclosure.

FIG. 5 is a flowchart illustrating a motion flow of the machine operation system according to the second embodiment of the present disclosure.

FIG. 6 is a diagram (part 1) illustrating a specific example of a motion of the machine operation system according to the second embodiment of the present disclosure.

FIG. 7 is a diagram (part 2) illustrating a specific example of a motion of the machine operation system according to the second embodiment of the present disclosure.

FIG. 8 is a flowchart illustrating a motion flow of the machine operation system according to the third embodiment of the present disclosure.

FIG. 9 is a diagram illustrating a specific example of a motion of the machine operation system according to the third embodiment of the present disclosure.

FIG. 10 is a diagram illustrating a machine operation system according to a fourth embodiment of the present disclosure.

FIG. 11 is a flowchart illustrating a motion flow in a setting mode of the machine operation system according to the fourth embodiment of the present disclosure.

FIG. 12 is a diagram illustrating a specific example of a motion in the setting mode of the machine operation system according to the fourth embodiment of the present disclosure.

FIG. 13 is a flowchart illustrating a motion flow in an operation mode of the machine operation system according to the fourth embodiment of the present disclosure.

FIG. 14 is a diagram illustrating a specific example of a motion in the operation mode of the machine operation system according to the fourth embodiment of the present disclosure.

FIG. 15 is a diagram illustrating a machine operation system according to a fifth embodiment of the present disclosure.

FIG. 16 is a flowchart illustrating a motion flow in a setting mode of the machine operation system according to the fifth embodiment of the present disclosure.

FIG. 17 is a diagram illustrating a specific example of a motion in the setting mode of the machine operation system according to the fifth embodiment of the present disclosure.

FIG. 18 is a diagram illustrating a machine operation system according to a modification example of the fifth embodiment of the present disclosure.

FIG. 19 is a flowchart illustrating a motion flow in an operation mode of the machine operation system according to the fifth embodiment of the present disclosure.

FIG. 20 is a diagram (part 1) illustrating a specific example of a motion in the operation mode of the machine operation system according to the fifth embodiment of the present disclosure.

FIG. 21 is a diagram (part 2) illustrating a specific example of a motion in the operation mode of the machine operation system according to the fifth embodiment of the present disclosure.

### DESCRIPTION OF EMBODIMENTS

A machine operation system and a computer program for executing authentication processing will be described below with reference to drawings. The same member is denoted by the same reference sign in each of the drawings. Further, a scale is changed in the drawings as appropriate in order to facilitate understanding. An illustrated aspect is one example for implementation, and the present disclosure is not limited to the illustrated aspect. A “manual operation on a robot or an industrial machine” means that a controller controls a motion of the robot or the industrial machine, based on a command emitted from a teaching operation device by operating the teaching operation device.

### First Embodiment

First, a machine operation system according to a first embodiment of the present disclosure will be described.

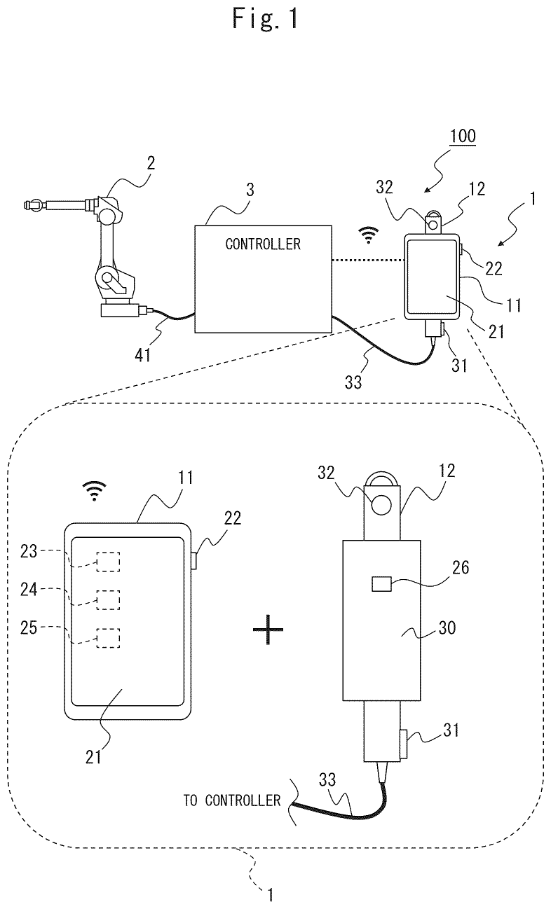

FIG. 1 is a diagram illustrating the machine operation system according to the first embodiment to a third embodiment of the present disclosure.

There is a robot, an industrial machine, or the like as a machine operated by a machine operation system 100 according to the first embodiment and each embodiment described below of the present disclosure, but a case where a robot 2 is operated is indicated as one example herein. When a machine operated by the machine operation system 100 is an industrial machine, the term “robot 2” in the description below may be replaced with a term “industrial machine”. Examples of the industrial machine include a machine tool, a forging machine, an injection molding machine, and the like.

The robot 2 and a controller 3 are connected by a cable 41 (hereinafter referred to as a “robot cable 41”) in such a way that wired communication can be achieved, and a motion of the robot 2 is controlled by the controller 3. An arithmetic processing device (processor) is provided in the controller 3. As the arithmetic processing device, for example, there are an IC, an LSI, a CPU, an MPU, a DSP, and the like. The controller 3 including the arithmetic processing device is, for example, a functional module achieved by a computer program executed on a processor. For example, when the controller 3 is constituted in a computer program form, the arithmetic processing device is operated according to the computer program, and thus each function for controlling a motion of the robot 2 can be achieved. Further, a computer program for executing processing of the controller 3 may be provided in form of being recorded in a computer-readable recording medium, such as a semiconductor memory, a magnetic recording medium, or an optical recording medium. Alternatively, the controller may be achieved as a semiconductor integrated circuit to which a computer program that achieves the function is written.

The machine operation system 100 according to the first embodiment of the present disclosure includes a wireless operation device 11 and a wired operation device 12. The wireless operation device 11 and the wired operation device 12 in combination constitute a teaching operation device 1.

The wireless operation device 11 is a general-purpose information terminal such as a tablet and a smartphone, for example. The wireless operation device 11 includes, for example, a touch panel 21 having both functions of screen display and input operation acceptance. As an alternative example, the wireless operation device 11 may include an indicator that performs screen display, and a physical operation button that performs input operation acceptance. The wireless operation device 11 includes a power supply button 22 for turning on power of the wireless operation device 11. The wireless operation device 11 is activated by the power supply button 22 being pressed (turned on) once. The wireless operation device 11 includes a battery (not illustrated) in the wireless operation device 11. Charging of the battery of the wireless operation device 11 is performed via a connector or a charging dock (charging stand) after the wireless operation device 11 is removed from the wired operation device 12.

An operation application software program for performing registration, editing, condition setting, and state display of a motion program related to the robot 2, teaching of the robot 2, a manual operation, and the like is installed in a storage unit (not illustrated) located in the wireless operation device 11, and an arithmetic processing device (not illustrated) also located in the wireless operation device 11 performs a motion according to the operation application software program installed in the storage unit, and thus the wireless operation device 11 achieves a wireless teaching operation function of operating (teaching) the robot 2. As the arithmetic processing device, for example, there are an IC, an LSI, a CPU, an MPU, a DSP, and the like. The storage unit is formed of a non-volatile memory being electrically deletable and recordable such as, for example, an EEPROM (registered trademark), a random access memory that can perform reading and writing at a high speed such as, for example, a DRAM and an SRAM, or the like. The wireless operation device 11 is connected to the controller 3 of the robot 2 via wireless communication, and includes a communication interface (not illustrated) for the connection. The wireless operation device 11 commands a motion of the robot 2 to the controller 3 in response to an operation content for the wireless operation device 11.

For example, narrow area wireless communication is used as the wireless communication between the wireless operation device 11 and the controller 3. The narrow area wireless communication indicates communication having a communication distance shorter than that of wide area wireless communication, and, specifically, indicates communication having the communication distance of less than 10 meters, for example. As the narrow area wireless communication, various types of short-range wireless communication having a short communication distance can be used, and communication conforming to any communication standard (for example, Wi-Fi (registered trademark), Bluetooth (registered trademark), ZigBee (registered trademark), and the like) developed by the IEEE, the ISO, the IEC, and the like, for example. As one example, the illustrated example indicates a case where communication conforming to Wi-Fi (registered trademark) is performed. As a technique for performing the narrow area wireless communication, for example, dedicated short range communication (DSRC), radio frequency identification (RFID), and the like are used.

The wired operation device 12 is connected to the controller 3 via wired communication, and includes a communication interface (not illustrated) for the connection. The wired operation device 12 and the controller 3 are connected via a cable 33 (hereinafter referred to as a “teaching operation device cable 33”). The wired operation device 12 includes an attachment base 30, and an enable switch 31 and an emergency stop button 32 as a safety switch.

The attachment base 30 is used for removably attaching the wireless operation device 11 to the wired operation device 12. As an attachment method of the wireless operation device 11 by the attachment base 30, there are, for example, a method for grasping the wireless operation device 11 by sandwiching the wireless operation device 11 by a spring mechanism provided in the wired operation device 12, a method for fastening the wireless operation device 11 with a screw, a method for sticking the wireless operation device 11 by using a sticking member, and the like. It should be noted that, regardless of presence or absence of attachment between the wireless operation device 11 and the wired operation device 12 by the attachment base 30, there is no direct electrical connection and communication between the wireless operation device 11 and the wired operation device 12, and communication between the wireless operation device 11 and the wired operation device 12 is performed via the controller 3.

The enable switch 31 is a safety switch that allows control of a motion of the robot 2 by the controller 3 via the wireless operation device 11 while the enable switch 31 is being pressed (turned on), and that does not allow control of a motion of the robot 2 by the controller 3 via the wireless operation device 11 by releasing pressing (turn-on). A signal in response to an operation content for the enable switch 31 is transmitted from the wired operation device 12 to the controller 3 via the teaching operation device cable 33. For example, while the enable switch 31 is not pressed, the robot 2 does not perform a motion even if any operation is performed via the wireless operation device 11. While the enable switch 31 is pressed, an operation of the robot 2 via the wireless operation device 11 can be achieved.

The emergency stop button 32 is a safety switch that commands an emergency stop of the robot 2 to the controller 3. When the emergency stop button 32 is pressed (turned on), an emergency stop signal is transmitted from the wired operation device 12 to the controller 3 via the teaching operation device cable 33, and the robot 2 makes an emergency stop in response to the signal.

Further, a non-contact authentication tag 26 is provided near or in the attachment base 30 of the wired operation device 12. A reader/writer function of reading and writing the non-contact authentication tag 26 is provided in the wireless operation device 11. The non-contact authentication tag 26 is formed of, for example, a near field communication (NFC) tag. The NFC is one kind of an individual identification technique by wireless communication using radio frequency identification (RFID). In the present embodiment, for example, ISO/IEC14443 is used as international standards of a proximity non-contact IC card. For example, ISO/IEC14443 defines that communication is performed by electromagnetic induction, a communicable distance between a reader/writer and a non-contact authentication tag is about 10 cm, a frequency of 13.56 MHz is used for communication, and the like. In the present embodiment, for example, ISO/IEC18092 (NFC IP-1) is used as international standards of a communication protocol. It should be noted that the other international standards of a proximity non-contact IC card and a communication protocol may be used.

The wireless operation device 11 includes an event detection unit 23, an authentication unit 24, and an application execution unit 25. The event detection unit 23, the authentication unit 24, and the application execution unit 25 are achieved as a function of the arithmetic processing device provided in the wireless operation device 11. FIG. 1 schematically illustrates the event detection unit 23, the authentication unit 24, and the application execution unit 25. The event detection unit 23, the authentication unit 24, and the application execution unit 25 may be constituted in a software program form, for example, or may be constituted by a combination of various electronic circuits and a software program. For example, when the event detection unit 23, the authentication unit 24, and the application execution unit 25 are constituted in the software program form, various software programs are installed in the storage unit (not illustrated) in the wireless operation device 11, an arithmetic processing unit (not illustrated) in the wireless operation device 11 performs a motion according to the software program installed in the storage unit, and thus a function of the event detection unit 23, the authentication unit 24, and the application execution unit 25 is achieved. Alternatively, the event detection unit 23, the authentication unit 24, and the application execution unit 25 may be achieved as a semiconductor integrated circuit to which a software program achieving a function of each of the units is written, and, in this case, the function of the event detection unit 23, the authentication unit 24, and the application execution unit 25 is achieved by installing the semiconductor integrated circuit in the wireless operation device 11.

The application execution unit 25 executes an operation application software program that controls the controller 3 in such a way that the robot 2 performs a motion in response to an operation content related to a teaching operation on the robot 2. When the operation application software program is executed by the application execution unit 25 (i.e., when the operation application software program is already activated), event detection processing by the event detection unit 23 is executed. The software program including the event detection unit 23 and the operation application software program may be separately implemented.

The event detection unit 23 detects an approach event in which the non-contact authentication tag 26 enters the inside of a first region being a predefined nearby region of the wireless operation device 11 from the outside of the first region, and a withdrawal event in which the non-contact authentication tag 26 exits the inside of the first region to the outside of the first region. In general, a general-purpose information terminal being the wireless operation device 11 is provided with a reader/writer function of reading and writing the non-contact authentication tag 26, and the event detection unit 23 detects an approach event and a withdrawal event via an application programming interface (API) of the reader/writer function. For example, in the reader/writer function according to ISO/IEC14443, a range of approximately 10 cm around the wireless operation device 11 can be set as the “first region” described above. It should be noted that the numerical value herein is one example, and the first region may be defined by using the other numerical value.

The event detection unit 23 detects occurrence of an approach event at a point in time at which the non-contact authentication tag 26 located outside the first region of the wireless operation device 11 gradually approaches the wireless operation device 11 and enters the inside of the first region of the wireless operation device 11. For example, the event detection unit 23 detects an approach event when the wireless operation device 11 located in a distant position gradually approaches the wired operation device 12 and is attached to the attachment base 30 of the wired operation device 12.

The event detection unit 23 detects occurrence of a withdrawal event at a point in time at which the non-contact authentication tag 26 located inside the first region of the wireless operation device 11 is gradually separated from the wireless operation device 11 and exits to the outside of the first region of the wireless operation device 11. For example, the event detection unit 23 detects a withdrawal event when the wireless operation device 11 attached to the attachment base 30 of the wired operation device 12 is removed from the wired operation device 12 and is gradually separated from the wired operation device 12, and the wired operation device 12 reaches the outside of the first region of the wireless operation device 11.

The authentication unit 24 determines whether an operation content for the wireless operation device 11 is valid or invalid in response to a content of an event detected by the event detection unit 23. When an approach event is detected by the event detection unit 23, the authentication unit 24 validates an operation content for the wireless operation device 11. When a withdrawal event is detected by the event detection unit 23, the authentication unit 24 invalidates an operation content for the wireless operation device 11. It should be noted that, when the wired operation device 12 and the wireless operation device 11 are in a non-operation state, the wireless operation device 11 does not command a motion of the robot 2 to the controller 3. When the wired operation device 12 and the wireless operation device 11 are in a non-operation state, and then an activation icon 51 displayed on the touch panel 21 and used for activating an operation application software program is pressed (touched) by a worker, the operation application software program is activated. When an approach event is detected by the event detection unit 23 during execution of the operation application software program by the application execution unit 25, an operation content for the wireless operation device 11 is validated by the authentication unit 24. When an operation content for the wireless operation device 11 is validated by the authentication unit 24, the worker can perform, by using the teaching operation device 1 formed of the wireless operation device 11 and the wired operation device 12, teaching (manual operation) of the robot 2, registration, editing, or condition setting of a motion program related to the robot 2, and the like as a manual operation on the robot 2 using the wireless operation device 11. When a withdrawal event is detected by the event detection unit 23 during execution of the operation application software program by the application execution unit 25, an operation content for the wireless operation device 11 is invalidated by the authentication unit 24. When an operation content for the wireless operation device 11 is invalidated by the authentication unit 24, the worker cannot command a motion of the robot 2 to the controller 3 by using the teaching operation device 1 formed of the wireless operation device 11 and the wired operation device 12.

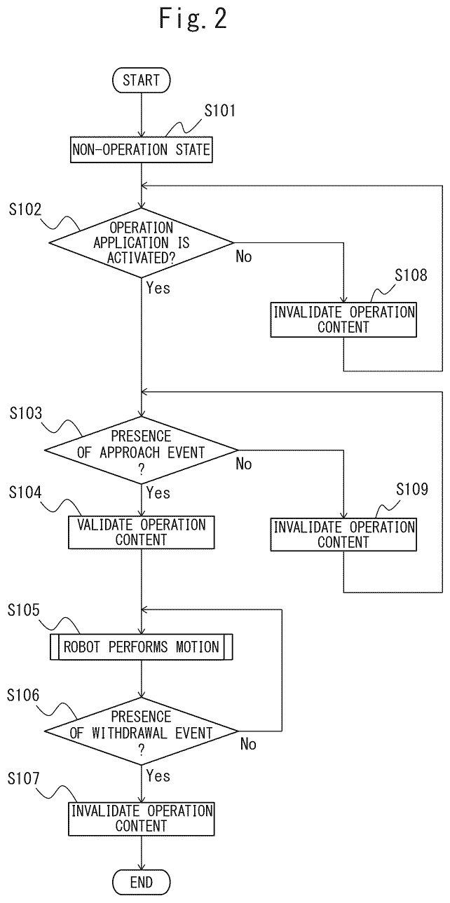

FIG. 2 is a diagram illustrating a motion flow of the machine operation system according to the first embodiment of the present disclosure.

When the wired operation device 12 and the wireless operation device 11 in step S101 are in a non-operation state, the wireless operation device 11 does not command a motion of the robot 2 to the controller 3.

In step S102, whether an operation application software program is activated is determined. The processing in step S102 may be executed by the event detection unit 23, may be executed by the authentication unit 24, or may be executed in a processing unit other than the event detection unit 23 and the authentication unit 24 being provided in the arithmetic processing device in the wireless operation device 11. The processing in step S102 is repeatedly executed in a predetermined cycle.

When it is not determined that the operation application software program is activated in step S102, the authentication unit 24 invalidates an operation content for the wireless operation device 11 in step S108. Subsequently, the processing returns to step S102.

When it is determined that the operation application software program is activated in step S102, the authentication unit 24 determines whether an approach event is detected by the event detection unit 23 in step S103. The processing in step S103 is repeatedly executed in a predetermined cycle.

When the approach event is not detected in step S103, the authentication unit 24 invalidates an operation content for the wireless operation device 11 in step S108. Subsequently, the processing returns to step S103.

When the approach event is detected in step S103, the authentication unit 24 validates an operation content for the wireless operation device 11 in step S104. In this way, a worker can perform teaching (manual operation) of the robot 2, registration, editing, or condition setting of a motion program related to the robot 2, and the like as a manual operation on the robot 2 using the wireless operation device 11. In response to the manual operation of the wireless operation device 11 by the worker, the controller 3 controls a motion of the robot 2 (step S105). It should be noted that, in the processing in step S105, an operation of the robot 2 via the wireless operation device 11 can be achieved while the enable switch 31 is pressed, and the robot 2 makes an emergency stop when the emergency stop button 32 is pressed.

In step S106, the authentication unit 24 determines whether a withdrawal event is detected by the event detection unit 23. The processing in step S106 is repeatedly executed in a predetermined cycle.

When the withdrawal event is not detected in step S106, the processing returns to step S105.

When the withdrawal event is detected in step S106, the authentication unit 24 invalidates an operation content for the wireless operation device 11 in step S107. In this way, the worker cannot command a motion of the robot 2 to the controller 3 by using the teaching operation device 1 formed of the wireless operation device 11 and the wired operation device 12.

It should be noted that, each step described above can be achieved in a form of a software program (hereinafter also referred to as a “computer program”) that can be executed by the arithmetic processing device in the wireless operation device 11. Creating a device that executes the processing described above and the software program that causes a computer to execute the processing described above is a matter that can be easily performed by a person skilled in the art. Further, storing, in a recording medium, a computer program that causes a computer to execute the processing described above is also obvious to the person skilled in the art.

The computer program for causing a computer (the arithmetic processing device in the wireless operation device 11) to execute authentication processing in the machine operation system 100 includes an event detection step, an authentication step, and an application execution step. In the event detection step, an approach event in which the non-contact authentication tag 26 enters the inside of a predefined first region of the wireless operation device 11 from the outside of the first region, and a withdrawal event in which the non-contact authentication tag 26 exits the inside of the first region to the outside of the first region are detected. In the authentication step, whether an operation content for the wireless operation device 11 is valid or invalid is determined in response to a content of an event detected in the event detection step. In other words, in the authentication step, an operation content for the wireless operation device 11 is validated when the approach event is detected in the event detection step, and an operation content for the wireless operation device 11 is invalidated when the withdrawal event is detected in the event detection step. In the application execution step, an operation application software program for controlling the controller 3 in such a way that the robot 2 performs a motion in response to an operation content related to a teaching operation on the robot 2 is executed. The event detection processing in the event detection step is executed when the operation application software program is executed by the application execution step.

Next, several specific examples of a motion of the machine operation system 100 according to the first embodiment of the present disclosure are listed.

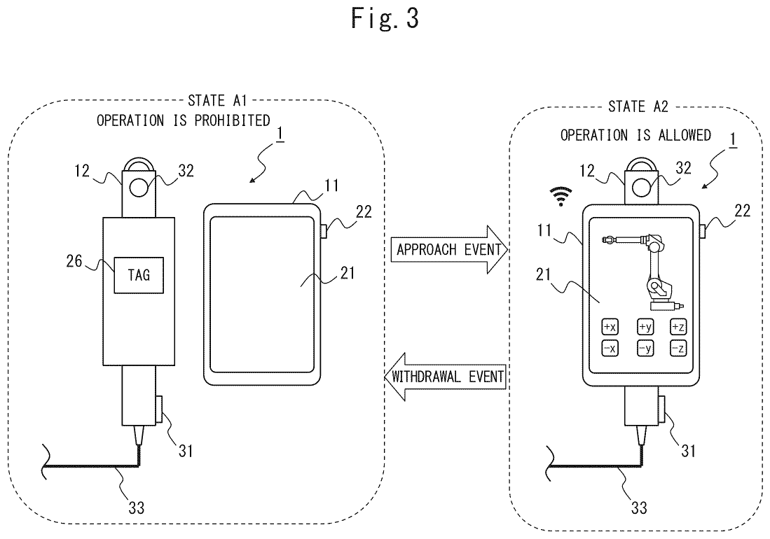

FIG. 3 is a diagram illustrating a first specific example of a motion of the machine operation system according to the first embodiment of the present disclosure.

In FIG. 3, in a state Al, the wireless operation device 11 is removed from the wired operation device 12, and the wired operation device 12 is located outside the first region of the wireless operation device 11. In the state A1, an operation content for the wireless operation device 11 is invalidated by the authentication unit 24, and thus an operation of the teaching operation device 1 formed of the wireless operation device 11 and the wired operation device 12 by a worker is prohibited.

In the state A1, when an operation application software program is activated, and, furthermore, the wireless operation device 11 is attached to the wired operation device 12, an approach event is detected by the event detection unit 23, and an operation content for the wireless operation device 11 is validated by the authentication unit 24, and thus the state Al shifts to a state A2. In the state A2, a teaching operation screen of the robot 2 based on the operation application software program is displayed on the touch panel 21. In this way, the worker can perform an operation such as teaching (manual operation) of the robot 2, and registration, editing, or condition setting of a motion program related to the robot 2 as an operation using the wireless operation device 11.

In the state A2, when the wireless operation device 11 is removed from the wired operation device 12, and the wired operation device 12 moves from the inside to the outside of the first region of the wireless operation device 11, a withdrawal event is detected by the event detection unit 23, and the state A2 shifts to the state A1. In the state A1, the withdrawal event is detected by the event detection unit 23, and an operation content for the wireless operation device 11 is invalidated by the authentication unit 24, and thus an operation of the teaching operation device 1 formed of the wireless operation device 11 and the wired operation device 12 by the worker is prohibited. Further, since a manual operation by the worker is set unavailable, a screen that prompts attachment of the wireless operation device 11 to the wired operation device 12 may be displayed on the touch panel 21 instead of displaying the teaching operation screen.

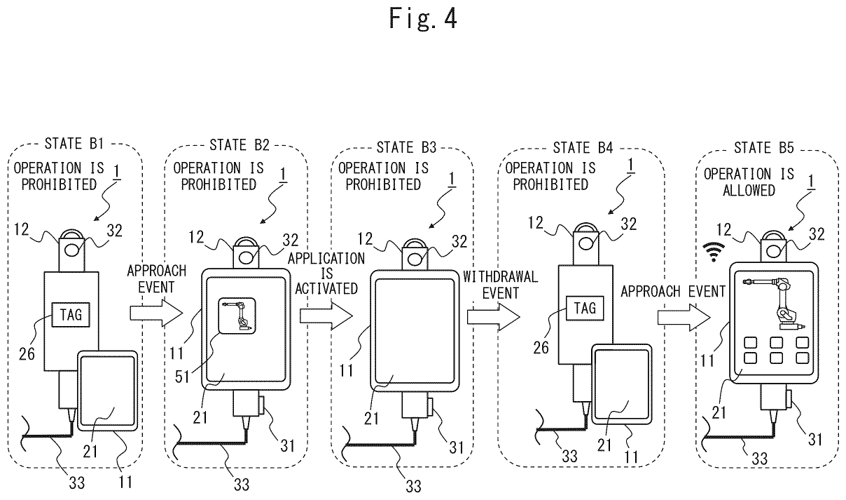

FIG. 4 is a diagram illustrating a second specific example of a motion of the machine operation system according to the first embodiment of the present disclosure.

In FIG. 4, in a state B1, the wireless operation device 11 is removed from the wired operation device 12, and the wired operation device 12 is located outside the first region of the wireless operation device 11. In the state B1, an operation content for the wireless operation device 11 is invalidated by the authentication unit 24, and thus an operation of the teaching operation device 1 formed of the wireless operation device 11 and the wired operation device 12 by a worker is prohibited. Further, in the state B1, an operation application software program is not activated.

In the state B1, when the wireless operation device 11 is attached to the wired operation device 12, an approach event occurs, and the state BI shifts to a state B2. However, in the state B2, the operation application software program is not yet executed (the operation application software program is not yet activated) by the application execution unit 25, and thus the event detection unit 23 cannot detect the approach event. Thus, an operation content for the wireless operation device 11 is invalidated, and an operation of the teaching operation device 1 formed of the wireless operation device 11 and the wired operation device 12 by the worker is still prohibited. In the state B2, the activation icon 51 for activating the operation application software program is displayed on the touch panel 21 instead of the teaching operation screen of the robot 2.

In the state B2, when the activation icon 51 is pressed (touched) by the worker, the operation application software program is activated, and the state B2 shifts to a state B3. In the state B3, the wireless operation device 11 is already attached to the wired operation device 12, and thus the event detection unit 23 does not detect the approach event. Thus, an operation content for the wireless operation device 11 is invalidated by the authentication unit 24, and thus an operation of the teaching operation device 1 formed of the wireless operation device 11 and the wired operation device 12 by the worker is still prohibited.

In the state B3, when the wireless operation device 11 is removed from the wired operation device 12, and the wired operation device 12 moves from the inside to the outside of the first region of the wireless operation device 11, a withdrawal event is detected by the event detection unit 23, and the state B3 shifts to a state B4. In the state B4, the withdrawal event is already detected by the event detection unit 23, and an operation content for the wireless operation device 11 is accordingly invalidated by the authentication unit 24, and thus an operation of the teaching operation device 1 formed of the wireless operation device 11 and the wired operation device 12 by the worker is still prohibited.

In the state B4, when the wireless operation device 11 is further attached to the wired operation device 12, the approach event is detected by the event detection unit 23, and the state B4 shifts to a state B5. In the state B5, the approach event is already detected by the event detection unit 23, and thus an operation content for the wireless operation device 11 is validated by the authentication unit 24. In the state B5, the teaching operation screen of the robot 2 based on the operation application software program is displayed on the touch panel 21. In this way, the worker can perform an operation such as teaching (manual operation) of the robot 2, and registration, editing, or condition setting of a motion program related to the robot 2 as an operation using the wireless operation device 11.

### Second Embodiment

Next, the machine operation system according to the second embodiment of the present disclosure will be described.

In the second embodiment of the present disclosure, when power of a wireless operation device 11 is turned on, an operation application software program is automatically activated as a background process, and event detection processing by an event detection unit 23 can be executed immediately after the power of the wireless operation device 11 is turned on. A configuration of a machine operation system 100 according to the second embodiment of the present disclosure is basically as described with reference to FIG. 1, but is different from the configuration of the machine operation system 100 according to the first embodiment of the present disclosure in the following points.

The second embodiment of the present disclosure includes a mode in which an operation application software program is executed as a background process, and a mode in which the operation application software program is executed as a foreground process. In both of the modes, the operation application software program is executed by an application execution unit 25, and thus the event detection processing by the event detection unit 23 is executed.

Switching from the background process of the operation application software program to the foreground process is performed when there is a teaching operation start command. The teaching operation start command is output by, for example, pressing (touching) an activation icon 51 displayed on a touch panel 21 of the wireless operation device 11 and used for activating the operation application software program. When the activation icon 51 displayed on the touch panel 21 is pressed, the teaching operation start command is transmitted from a control unit (not illustrated) configured to control a motion of the wireless operation device 11 to the application execution unit 25 in an arithmetic processing device in the wireless operation device 11.

Switching from the foreground process of the operation application software program to the background process is performed when there is a teaching operation end command. The teaching operation end command is output by, for example, pressing (touching) an end button (not illustrated) displayed on the touch panel 21 of the wireless operation device 11 and used for ending the operation application software program in a teaching operation screen. When the end button displayed on the touch panel 21 is pressed, the teaching operation end command is transmitted from the control unit (not illustrated) configured to control a motion of the wireless operation device 11 to the application execution unit 25 in the arithmetic processing device in the wireless operation device 11.

Power of the wireless operation device 11 is turned on by a power supply button 22 of the wireless operation device 11 being pressed (turned on). The application execution unit 25 activates the operation application software program as the background process when the power of the wireless operation device 11 is turned on.

The application execution unit 25 performs control of not displaying the teaching operation screen on the touch panel 21 while the operation application software program is executed as the background process. While the operation application software program is executed as the background process, a worker can use an application software program other than the operation application software program in a general-purpose information terminal being the wireless operation device 11.

Further, when there is the teaching operation start command while the operation application software program is executed as the background process, the application execution unit 25 switches the operation application software program to the foreground process and executes the operation application software program. The application execution unit 25 performs control of displaying the teaching operation screen on the touch panel 21 while the operation application software program is executed as the foreground process.

Further, when there is the teaching operation end command while the operation application software program is executed as the foreground process, the application execution unit 25 switches the operation application software program to the background process and executes the operation application software program.

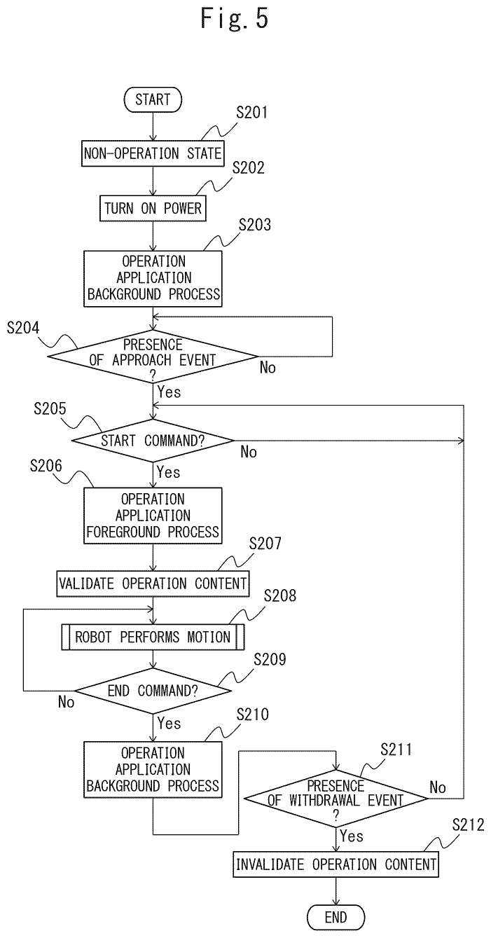

FIG. 5 is a flowchart illustrating a motion flow of the machine operation system according to the second embodiment of the present disclosure.

When a wired operation device 12 and the wireless operation device 11 in step S201 are in a non-operation state, the wireless operation device 11 does not command a motion of a robot 2 to a controller 3. Further, at a point in time of step $101, the power of the wireless operation device 11 is not turned on.

In step S202, the power of the wireless operation device 11 is turned on by the power supply button 22 of the wireless operation device 11 being pressed (turned on).

In step S203, the application execution unit 25 executes an operation application software program as a background process. During execution of step S203, the application execution unit 25 performs control of not displaying the teaching operation screen on the touch panel 21. Further, during execution of step S203, an authentication unit 24 invalidates an operation content for the wireless operation device 11. Further, during execution of step S203, a worker can use an application software program other than the operation application software program in the general-purpose information terminal being the wireless operation device 11.

In step S204, the authentication unit 24 determines whether an approach event is detected by the event detection unit 23. The processing in step S204 is repeatedly executed in a predetermined cycle.

When the approach event is detected in step S204, the application execution unit 25 determines whether there is a teaching operation start command in step S205. The processing in step S205 is repeatedly executed in a predetermined cycle.

When it is determined that there is the teaching operation start command in step S205, the application execution unit 25 executes the operation application software program as a foreground process in step S206. During execution of step S206, the application execution unit 25 performs control of displaying the teaching operation screen on the touch panel 21.

In step S207, the authentication unit 24 validates an operation content for the wireless operation device 11. In this way, the worker can perform teaching (manual operation) of the robot 2, registration, editing, or condition setting of a motion program related to the robot 2, and the like as a manual operation on the robot 2 using the wireless operation device 11. In response to the manual operation of the wireless operation device 11 by the worker, the controller 3 controls a motion of the robot 2 (step S208). It should be noted that, in the processing in step S105, an operation of the robot 2 via the wireless operation device 11 can be achieved while an enable switch 31 is pressed, and the robot 2 makes an emergency stop when an emergency stop button 32 is pressed.

In step S209, the application execution unit 25 determines whether there is a teaching operation end command. The processing in step S209 is repeatedly executed in a predetermined cycle.

When it is not determined that there is the teaching operation end command in step S209, the processing returns to step S208.

When it is determined that there is the teaching operation end command in step S209, the application execution unit 25 executes the operation application software program as the background process in step S210. During execution of step S210, the application execution unit 25 performs control of not displaying the teaching operation screen on the touch panel 21. Further, during execution of step S210, the worker can use an application software program other than the operation application software program in the general-purpose information terminal being the wireless operation device 11.

In step S211, the authentication unit 24 determines whether a withdrawal event is detected by the event detection unit 23. The processing in step S211 is repeatedly executed in a predetermined cycle.

When the withdrawal event is not detected in step S211, the processing returns to step S205.

When the withdrawal event is detected in step S211, the authentication unit 24 invalidates an operation content for the wireless operation device 11 in step S212. In this way, the worker cannot command a motion of the robot 2 to the controller 3 by using a teaching operation device 1 formed of the wireless operation device 11 and the wired operation device 12.

It should be noted that, each step described above can be achieved in a form of a software program (computer program) that can be executed by the arithmetic processing device in the wireless operation device 11. Creating a device that executes the processing described above and the software program that causes a computer to execute the processing described above is a matter that can be easily performed by a person skilled in the art. Further, storing, in a recording medium, a computer program that causes a computer to execute the processing described above is also obvious to the person skilled in the art.

The computer program for causing a computer (the arithmetic processing device in the wireless operation device 11) to execute authentication processing in the machine operation system 100 includes an event detection step, an authentication step, and an application execution step. In the event detection step, an approach event in which the non-contact authentication tag 26 enters the inside of a predefined first region of the wireless operation device 11 from the outside of the first region, and a withdrawal event in which the non-contact authentication tag 26 exits the inside of the first region to the outside of the first region are detected. In the authentication step, whether an operation content for the wireless operation device 11 is valid or invalid is determined in response to a content of an event detected in the event detection step. In other words, in the authentication step, an operation content for the wireless operation device 11 is validated when the approach event is detected in the event detection step, and an operation content for the wireless operation device 11 is invalidated when the withdrawal event is detected in the event detection step. In the application execution step, an operation application software program that controls the controller 3 in such a way that the robot 2 performs a motion in response to an operation content related to a teaching operation on the robot 2 is executed. The event detection processing in the event detection step is executed when the operation application software program is executed by the application execution step. The application execution step is activated when power of the wireless operation device is turned on. Further, in the application execution step, the operation application software program is executed as a background process until there is a teaching operation start command to the wireless operation device 11 after activation of the operation application software program, and the operation application software program is executed as a foreground process after there is the teaching operation start command. Further, in the application execution step, after there is a teaching operation end command to the wireless operation device 11 while the operation application software program is executed as the foreground process, the operation application software program is executed as the background process. Further, in the application execution step, while the operation application software program is executed as the background process, control of not displaying the teaching operation screen on the touch panel 21 is performed, and, while the operation application software program is executed as the foreground process, control of displaying the teaching operation screen on the touch panel 21 is performed.

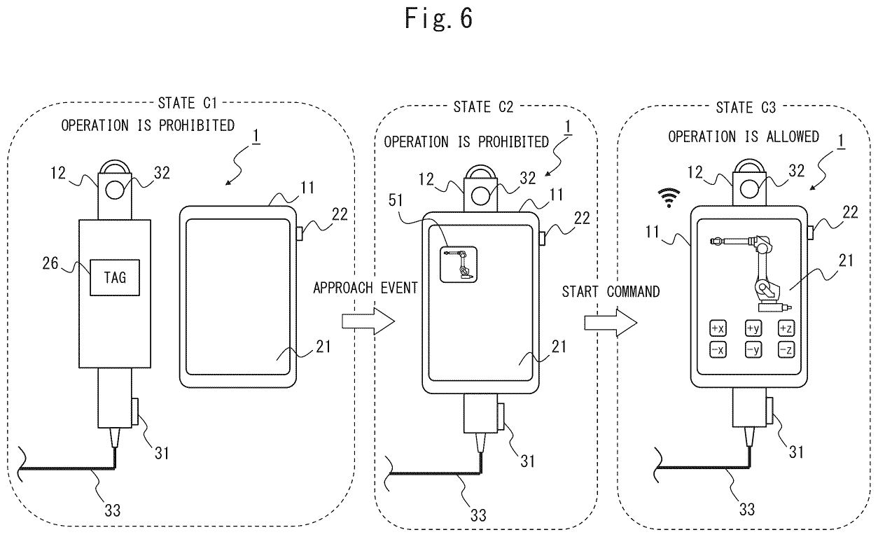

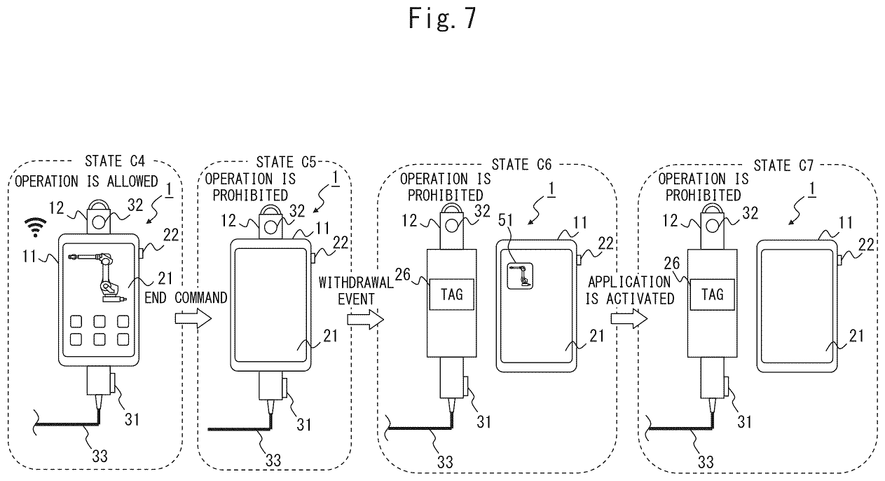

FIGS. 6 and 7 are diagrams illustrating a specific example of a motion of the machine operation system according to the second embodiment of the present disclosure.

In FIG. 6, in a state C1, the wireless operation device 11 is removed from the wired operation device 12, and the wired operation device 12 is located outside the first region of the wireless operation device 11. Further, in the state C1, the power of the wireless operation device 11 is not turned on. In the state C1, an operation content for the wireless operation device 11 is invalidated, and an operation of the teaching operation device 1 formed of the wireless operation device 11 and the wired operation device 12 by a worker is prohibited.

In the state C1, when the power is turned on while the wireless operation device 11 is removed from the wired operation device 12, an operation application software program is executed as a background process. The operation application software program is executed, and thus, when the wireless operation device 11 is attached to the wired operation device 12, an approach event is detected by the event detection unit 23, and the state C1 shifts to a state C2. In the state C2, the activation icon 51 for activating the operation application software program is displayed on the touch panel 21 instead of the teaching operation screen of the robot 2. In the state C2, the activation icon 51 is not pressed (touched), and thus a teaching operation start command is not output. Therefore, an operation content for the wireless operation device 11 is still invalidated by the authentication unit 24, and an operation of the teaching operation device 1 formed of the wireless operation device 11 and the wired operation device 12 by the worker is prohibited.

In the state C2, when the activation icon 51 is pressed, the state C2 shifts to a state C3. In the state C3, the teaching operation start command is output by pressing the activation icon 51, and thus the operation application software program is executed as a foreground process. Therefore, in the state C3, the teaching operation screen is displayed on the touch panel 21, and an operation content for the wireless operation device 11 is validated by the authentication unit 24. In this way, the worker can perform an operation such as teaching (manual operation) of the robot 2, and registration, editing, or condition setting of a motion program related to the robot 2 as an operation using the wireless operation device 11.

A state C4 in FIG. 7 is the same as the state C3 in FIG. 6.

In the state C4, when an end button is pressed in the teaching operation screen of the touch panel 21 of the wireless operation device 11, the state C4 shifts to a state C5. In the state C5, a teaching operation end command is output by pressing the end button, and thus the operation application software program is executed as the background process. Therefore, in the state C5, an operation content for the wireless operation device 11 is invalidated by the authentication unit 24, and thus an operation of the teaching operation device 1 formed of the wireless operation device 11 and the wired operation device 12 by the worker is prohibited. Further, in the state C5, the activation icon 51 for activating the operation application software program is displayed on the touch panel 21 instead of the teaching operation screen.

In the state C5, when the wireless operation device 11 is removed from the wired operation device 12, and the wired operation device 12 moves from the inside to the outside of the first region of the wireless operation device 11, a withdrawal event is detected by the event detection unit 23, and the state C5 shifts to a state C6. In the state C6, the withdrawal event is already detected by the event detection unit 23, and an operation content for the wireless operation device 11 is accordingly invalidated by the authentication unit 24, and thus an operation of the teaching operation device 1 formed of the wireless operation device 11 and the wired operation device 12 by the worker is still prohibited.

In the state C6, when the activation icon 51 is pressed (touched) by the worker, the state C6 shifts to a state C7. In the state C7, the teaching operation start command is output by pressing the activation icon 51, and thus the operation application software program is executed as the foreground process. However, in the state C7, the wireless operation device 11 is removed from the wired operation device 12, and the approach event is not detected by the event detection unit 23, and thus an operation content for the wireless operation device 11 is invalidated by the authentication unit 24. Thus, an operation of the teaching operation device 1 formed of the wireless operation device 11 and the wired operation device 12 by the worker is still prohibited.

### Third Embodiment

Next, the machine operation system according to the third embodiment of the present disclosure will be described.

The third embodiment of the present disclosure is acquired by further improving operability of a worker. In the third embodiment of the present disclosure, execution of an operation application software program is automatically switched between a background process and a foreground process in response to detection of an approach event and a withdrawal event by an event detection unit 23. A configuration of a machine operation system 100 according to the third embodiment of the present disclosure is basically as described with reference to FIG. 1, but is different from the configuration of the machine operation system 100 according to the first embodiment of the present disclosure in the following points.

When an approach event is detected by the event detection unit 23 while an application execution unit 25 executes the operation application software program as the background process, the application execution unit 25 executes the operation application software program as the foreground process. Further, when a withdrawal event is detected by the event detection unit 23 while the application execution unit 25 executes the operation application software program as the foreground process, the application execution unit 25 executes the operation application software program as the background process.

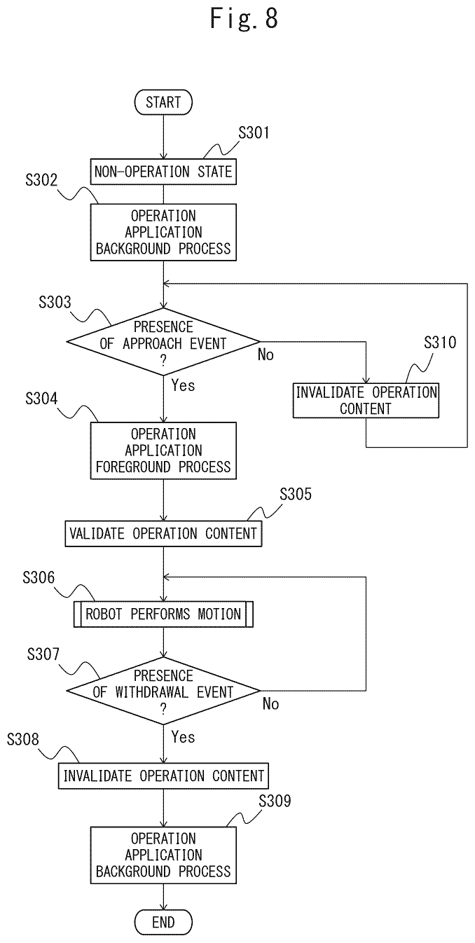

FIG. 8 is a flowchart illustrating a motion flow of the machine operation system according to the third embodiment of the present disclosure.

When a wired operation device 12 and a wireless operation device 11 in step S301 are in a non-operation state, the wireless operation device 11 does not command a motion of a robot 2 to a controller 3.

In step S302, when an activation icon 51 displayed on a touch panel 21 and used for activating an operation application software program is pressed (touched) by a worker, the operation application software program is activated. The application execution unit 25 executes the operation application software program as a background process immediately after activation of the operation application software program.

In step S303, an authentication unit 24 determines whether an approach event is detected by the event detection unit 23. The processing in step S303 is repeatedly executed in a predetermined cycle.

When the approach event is not detected in step S303, the authentication unit 24 invalidates an operation content for the wireless operation device 11 in step S310. Subsequently, the processing returns to step S303.

When the approach event is detected in step S303, the application execution unit 25 executes the operation application software program as a foreground process in step S304.

In step S305, the authentication unit 24 validates an operation content for the wireless operation device 11. In this way, the worker can perform teaching (manual operation) of the robot 2, registration, editing, or condition setting of a motion program related to the robot 2, and the like as a manual operation on the robot 2 using the wireless operation device 11. In response to the manual operation of the wireless operation device 11 by the worker, the controller 3 controls a motion of the robot 2 (step S306). It should be noted that, in the processing in step S306, an operation of the robot 2 via the wireless operation device 11 can be achieved while an enable switch 31 is pressed, and the robot 2 makes an emergency stop when an emergency stop button 32 is pressed.

In step S307, the authentication unit 24 determines whether a withdrawal event is detected by the event detection unit 23. The processing in step S307 is repeatedly executed in a predetermined cycle.

When the withdrawal event is not detected in step S307, the processing returns to step S306.

When the withdrawal event is detected in step S307, the authentication unit 24 invalidates an operation content for the wireless operation device 11 in step S308. In this way, the worker cannot command a motion of the robot 2 to the controller 3 by using a teaching operation device 1 formed of the wireless operation device 11 and the wired operation device 12.

In step S309, the application execution unit 25 executes the operation application software program as the background process.

It should be noted that, each step described above can be achieved in a form of a software program (computer program) that can be executed by the arithmetic processing device in the wireless operation device 11. Creating a device that executes the processing described above and the software program that causes a computer to execute the processing described above is a matter that can be easily performed by a person skilled in the art. Further, storing, in a recording medium, a computer program that causes a computer to execute the processing described above is also obvious to the person skilled in the art.

The computer program for causing a computer (the arithmetic processing device in the wireless operation device 11) to execute authentication processing in the machine operation system 100 includes an event detection step, an authentication step, and an application execution step. In the event detection step, an approach event in which a non-contact authentication tag 26 enters the inside of a predefined first region of the wireless operation device 11 from the outside of the first region, and a withdrawal event in which the non-contact authentication tag 26 exits the inside of the first region to the outside of the first region are detected. In the authentication step, whether an operation content for the wireless operation device 11 is valid or invalid is determined in response to a content of an event detected in the event detection step. In other words, in the authentication step, an operation content for the wireless operation device 11 is validated when the approach event is detected in the event detection step, and an operation content for the wireless operation device 11 is invalidated when the withdrawal event is detected in the event detection step. In the application execution step, an operation application software program that controls the controller 3 in such a way that the robot 2 performs a motion in response to an operation content related to a teaching operation on the robot 2 is executed. In the application execution step, when the approach event is detected in the event detection step while the operation application software program is executed as a background process, the operation application software program is executed as a foreground process. Further, in the application execution step, when the withdrawal event is detected in the event detection step while the operation application software program is executed as the foreground process, the operation application software program is executed as the background process.

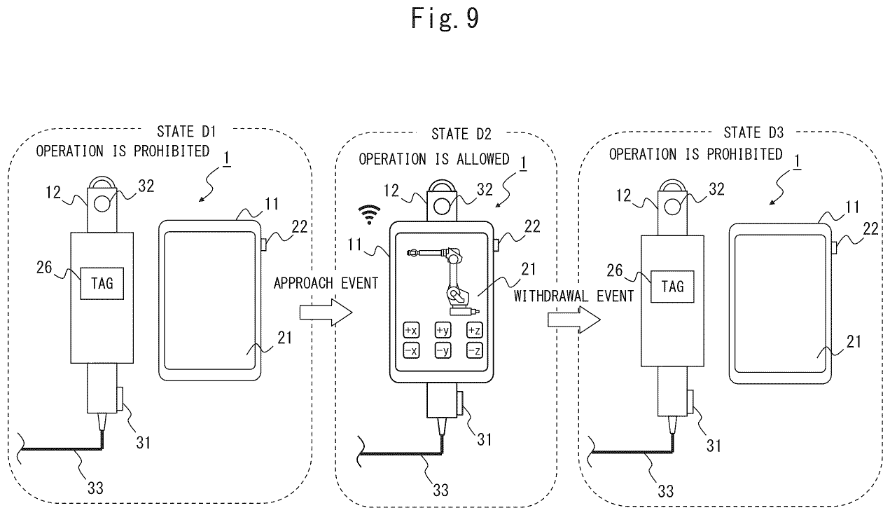

FIG. 9 is a diagram illustrating a specific example of a motion of the machine operation system according to the third embodiment of the present disclosure.

In FIG. 9, in a state D1, the wireless operation device 11 is removed from the wired operation device 12, and the wired operation device 12 is located outside the first region of the wireless operation device 11. In the state D1, an operation content for the wireless operation device 11 is invalidated by the authentication unit 24, and an operation of the teaching operation device 1 formed of the wireless operation device 11 and the wired operation device 12 by a worker is prohibited. Further, in the state D1, an operation application software program is executed as a background process, and a teaching operation screen is not displayed on the touch panel 21.

In the state D1, when the wireless operation device 11 is attached to the wired operation device 12, an approach event occurs, and the state D1 shifts to a state D2. In the state D2, the approach event is detected by the event detection unit 23, and thus the operation application software program is executed as a foreground process. In the state D2, the teaching operation screen is displayed on the touch panel 21, and an operation content for the wireless operation device 11 is validated by the authentication unit 24. In this way, the worker can perform an operation such as teaching (manual operation) of the robot 2, and registration, editing, or condition setting of a motion program related to the robot 2 as an operation using the wireless operation device 11.

In the state D2, when the wireless operation device 11 is removed from the wired operation device 12, and the wired operation device 12 moves from the inside to the outside of the first region of the wireless operation device 11, a withdrawal event is detected by the event detection unit 23, and the state D2 shifts to a state D3. In the state D3, the withdrawal event is detected by the event detection unit 23, and thus the operation application software program is executed as the background process. In the state D3, the teaching operation screen is not displayed on the touch panel 21. Further, an operation content for the wireless operation device 11 is invalidated by the authentication unit 24, and thus an operation of the teaching operation device 1 formed of the wireless operation device 11 and the wired operation device 12 by the worker is prohibited.

### Fourth Embodiment

Next, a machine operation system according to a fourth embodiment of the present disclosure will be described.

In the fourth embodiment of the present disclosure, an identifier unique to a wired operation device 12 provided with a non-contact authentication tag 26 is recorded in advance in the non-contact authentication tag 26, and a pairing of a wireless operation device 11 and the wired operation device 12 is managed based on the identifier.

The fourth embodiment of the present disclosure includes a setting mode of pairing the wireless operation device 11 and the wired operation device 12, and a normal operation mode as a teaching operation device 1. The setting mode is performed in advance before the operation mode.

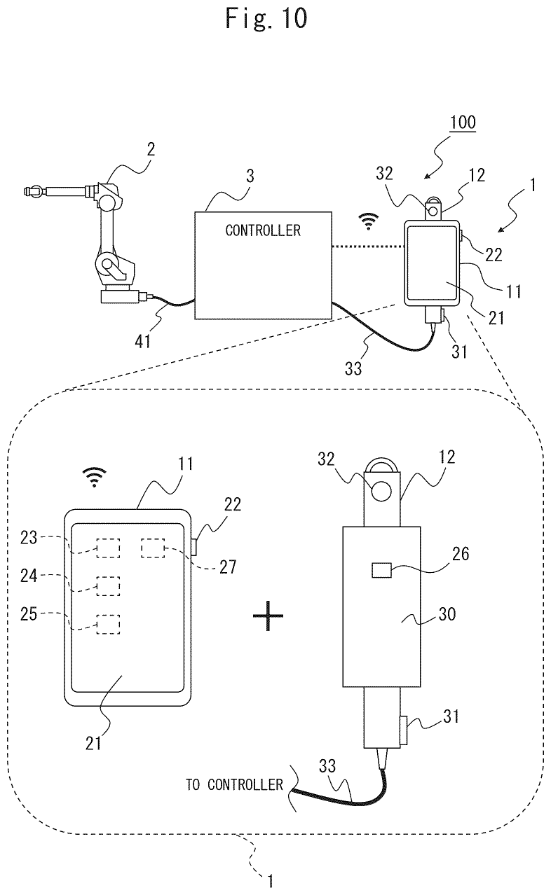

FIG. 10 is a diagram illustrating the machine operation system according to the fourth embodiment of the present disclosure.

As illustrated in FIG. 10, a machine operation system 100 according to the fourth embodiment of the present disclosure further includes an identifier acquisition unit 27 in the wireless operation device 11 of the machine operation system 100 illustrated in FIG. 1. A robot 2, a controller 3, a teaching operation device cable 33, and a robot cable 41 are as described with reference to FIG. 1.

An identifier unique to the wired operation device 12 is recorded in the non-contact authentication tag 26 provided in the wired operation device 12. Therefore, when there are a plurality of the wired operation devices 12, an identifier unique to each of the wired operation devices 12 is assigned to the non-contact authentication tag 26 of each of the wired operation devices 12. A configuration of the wired operation device 12 other than the non-contact authentication tag 26 is as described with reference to FIG. 1.

The wireless operation device 11 includes the identifier acquisition unit 27 in addition to an event detection unit 23, an authentication unit 24, and an application execution unit 25. FIG. 10 schematically illustrates the event detection unit 23, the authentication unit 24, the application execution unit 25, and the identifier acquisition unit 27.

The event detection unit 23, the application execution unit 25, a touch panel 21, and a power supply button 22 are as described with reference to FIG. 1.

The identifier acquisition unit 27 acquires an identifier of the non-contact authentication tag 26 when an approach event is detected by the event detection unit 23. In both of the setting mode and the operation mode, identifier acquisition processing may be executed by the identifier acquisition unit 27.

In the operation mode, the authentication unit 24 validates an operation content for the wireless operation device 11 when an identifier acquired by the identifier acquisition unit 27 coincides with an identifier acquired in advance by the identifier acquisition unit 27 in the setting mode. Further, in the operation mode, the authentication unit 24 invalidates an operation content for the wireless operation device 11 when an identifier acquired by the identifier acquisition unit 27 does not coincide with the identifier acquired in advance by the identifier acquisition unit 27 in the setting mode.

The event detection unit 23, the authentication unit 24, the application execution unit 25, and the identifier acquisition unit 27 may be constituted in a software program form, for example, or may be constituted by a combination of various electronic circuits and a software program. For example, when the event detection unit 23, the authentication unit 24, the application execution unit 25, and the identifier acquisition unit 27 are constituted in the software program form, various software programs are installed in the storage unit (not illustrated) in the wireless operation device 11, an arithmetic processing unit (not illustrated) in the wireless operation device 11 performs a motion according to the software program installed in the storage unit, and thus a function of the event detection unit 23, the authentication unit 24, the application execution unit 25, and the identifier acquisition unit 27 is achieved. Alternatively, the event detection unit 23, the authentication unit 24, the application execution unit 25, and the identifier acquisition unit 27 may be achieved as a semiconductor integrated circuit to which a software program achieving a function of each of the units is written, and, in this case, the function of the event detection unit 23, the authentication unit 24, the application execution unit 25, and the identifier acquisition unit 27 is achieved by installing the semiconductor integrated circuit in the wireless operation device 11.

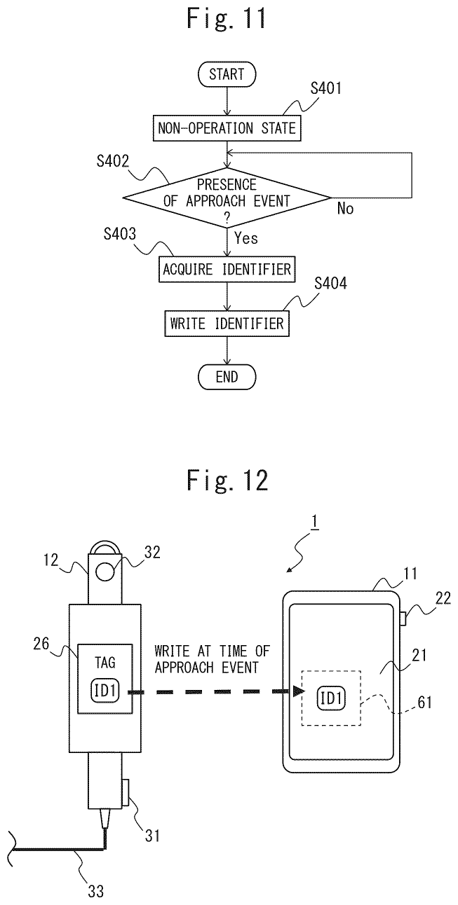

FIG. 11 is a flowchart illustrating a motion flow in the setting mode of the machine operation system according to the fourth embodiment of the present disclosure.

When the wired operation device 12 and the wireless operation device 11 in step S401 are in a non-operation state, the wireless operation device 11 does not command a motion of the robot 2 to the controller 3. In step S401, a worker activates an operation application software program by pressing (touching) an activation icon 51, and a teaching operation screen is displayed on the touch panel 21. Then, the worker activates the setting mode on the operation application software program. The setting mode is activated by, for example, pressing (touching) a setting mode activation button of the teaching operation screen.

In step S402, the authentication unit 24 determines whether an approach event is detected by the event detection unit 23. The processing in step S402 is repeatedly executed in a predetermined cycle.

When the worker attaches the wireless operation device 11 to the wired operation device 12, the event detection unit 23 detects the approach event, and thus the authentication unit 24 determines that the approach event is detected by the event detection unit 23 in step S402, and the processing then proceeds to step S403.

In step S403, the identifier acquisition unit 27 acquires an identifier of the non-contact authentication tag 26.

In step S404, the identifier acquisition unit 27 writes the acquired identifier of the non-contact authentication tag 26 to a storage unit (not illustrated in FIG. 10) in the wireless operation device 11. In this way, pairing of the wireless operation device 11 and the wired operation device 12 is completed, and thus the setting mode ends.

FIG. 12 is a diagram illustrating a specific example of a motion in the setting mode of the machine operation system according to the fourth embodiment of the present disclosure. It should be noted that FIG. 12 illustrates the wireless operation device 11 and the wired operation device 12 being detached from each other for simplifying the description, but it is assumed that the wireless operation device 11 is actually attached to the wired operation device 12.

In FIG. 12, an identifier IDI unique to the wired operation device 12 provided with the non-contact authentication tag 26 is recorded in the non-contact authentication tag 26. When a worker attaches the wireless operation device 11 to the wired operation device 12, the event detection unit 23 detects an approach event, and thus the authentication unit 24 determines that the approach event is detected by the event detection unit 23. In response to detection of the approach event by the event detection unit 23, the identifier acquisition unit 27 acquires the identifier ID1 of the non-contact authentication tag 26, and writes the identifier ID1 to a storage unit 81 in the wireless operation device 11. In this way, pairing of the wireless operation device 11 and the wired operation device 12 is completed.

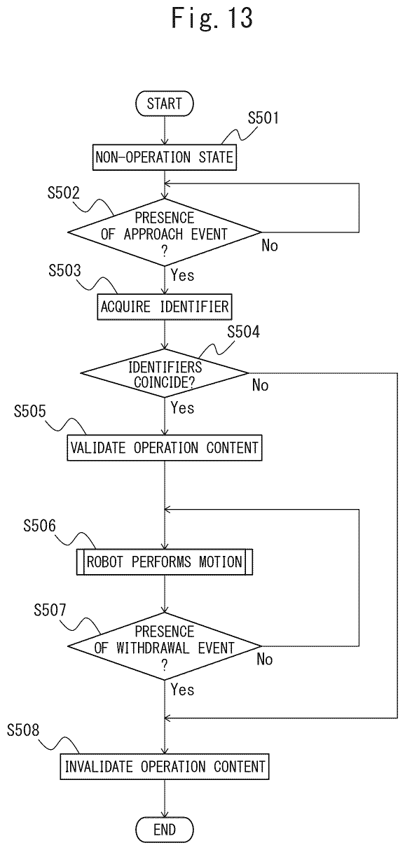

FIG. 13 is a flowchart illustrating a motion flow in the operation mode of the machine operation system according to the fourth embodiment of the present disclosure.

At a stage of step S501, pairing of the wireless operation device 11 and the wired operation device 12 in the setting mode is already completed. A worker activates an operation application software program by pressing (touching) the activation icon 51, and displays a teaching operation screen on the touch panel 21. Then, the worker activates the operation mode on the operation application software program. The operation mode is activated by pressing (touching), for example, an operation mode activation button of the teaching operation screen. When the wired operation device 12 and the wireless operation device 11 in step S501 are in a non-operation state, the wireless operation device 11 does not command a motion of the robot 2 to the controller 3.

In step S502, the authentication unit 24 determines whether an approach event is detected by the event detection unit 23. The processing in step S502 is repeatedly executed in a predetermined cycle.

When the worker attaches the wireless operation device 11 to the wired operation device 12, the event detection unit 23 detects the approach event, and thus the authentication unit 24 determines that the approach event is detected by the event detection unit 23 in step S502, and the processing then proceeds to step S503.

In step S503, the identifier acquisition unit 27 acquires an identifier of the non-contact authentication tag 26.

In step S504, the authentication unit 24 determines whether the identifier acquired by the identifier acquisition unit 27 in step S503 coincides with the identifier acquired by the identifier acquisition unit 27 and stored in the storage unit in the setting mode.

When it is determined that the identifiers coincide with each other in step S504, the authentication unit 24 validates an operation content for the wireless operation device 11 in step S505. In this way, the worker can perform teaching (manual operation) of the robot 2, registration, editing, or condition setting of a motion program related to the robot 2, and the like as a manual operation on the robot 2 using the wireless operation device 11. In response to the manual operation of the wireless operation device 11 by the worker, the controller 3 controls a motion of the robot 2 (step S506). It should be noted that, in the processing in step S506, an operation of the robot 2 via the wireless operation device 11 can be achieved while an enable switch 31 is pressed, and the robot 2 makes an emergency stop when an emergency stop button 32 is pressed.

In step S507, the authentication unit 24 determines whether a withdrawal event is detected by the event detection unit 23. The processing in step S507 is repeatedly executed in a predetermined cycle.

When the withdrawal event is not detected in step S507, the processing returns to step S506.

When the withdrawal event is detected in step S507, the authentication unit 24 invalidates an operation content for the wireless operation device 11 in step S508. In this way, the worker cannot command a motion of the robot 2 to the controller 3 by using a teaching operation device 1 formed of the wireless operation device 11 and the wired operation device 12.

Further, in step S504, when it is not determined that the identifier acquired by the identifier acquisition unit 27 in step S503 does not coincide with the identifier acquired by the identifier acquisition unit 27 and stored in the storage unit in the setting mode, the authentication unit 24 also invalidates an operation content for the wireless operation device 11 in step S508. In this way, the worker cannot command a motion of the robot 2 to the controller 3 by using the teaching operation device 1 formed of the wireless operation device 11 and the wired operation device 12.

It should be noted that, each step described above can be achieved in a form of a software program (computer program) that can be executed by the arithmetic processing device in the wireless operation device 11. Creating a device that executes the processing described above and the software program that causes a computer to execute the processing described above is a matter that can be easily performed by a person skilled in the art. Further, storing, in a recording medium, a computer program that causes a computer to execute the processing described above is also obvious to the person skilled in the art.

The computer program for causing a computer (the arithmetic processing device in the wireless operation device 11) to execute authentication processing in the machine operation system 100 includes an event detection step, an authentication step, an application execution step, and an identifier acquisition step. In the event detection step, an approach event in which the non-contact authentication tag 26 enters the inside of a predefined first region of the wireless operation device 11 from the outside of the first region, and a withdrawal event in which the non-contact authentication tag 26 exits the inside of the first region to the outside of the first region are detected. In the application execution step, an operation application software program that controls the controller 3 in such a way that the robot 2 performs a motion in response to an operation content related to a teaching operation on the robot 2 is executed. In the identifier acquisition step, an identifier unique to the wired operation device 12 of the non-contact authentication tag 26 is acquired when the approach event is detected in the event detection step. In the authentication step, whether an operation content for the wireless operation device 11 is valid or invalid is determined in response to a content of an event detected in the event detection step. In other words, in the authentication step, in the operation mode, an operation content for the wireless operation device 11 is validated when an identifier acquired in the identifier acquisition step coincides with an identifier acquired in advance by in the identifier acquisition step in the setting mode. Further, in the authentication step, in the operation mode, an operation content for the wireless operation device 11 is invalidated when an identifier acquired in the identifier acquisition step does not coincide with the identifier acquired in advance in the identifier acquisition step in the setting mode.

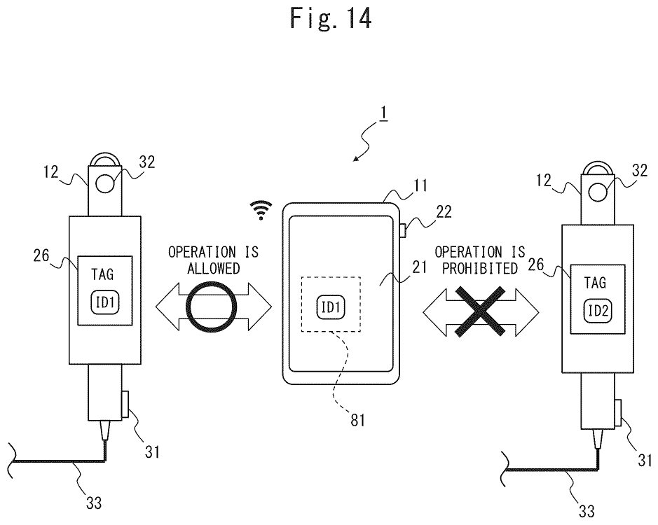

FIG. 14 is a diagram illustrating a specific example of a motion in the operation mode of the machine operation system according to the fourth embodiment of the present disclosure.

In FIG. 14, it is assumed that pairing of the wireless operation device 11 and the wired operation device 12 in the setting mode is already completed, and the identifier ID1 of the non-contact authentication tag 26 acquired in the setting mode is stored in the storage unit 81 of the wireless operation device 11. It should be noted that FIG. 14 illustrates the wireless operation device 11 and the wired operation device 12 being detached from each other for simplifying the description, but it is assumed that the wireless operation device 11 is actually attached to the wired operation device 12.

When the wireless operation device 11 is attached to the wired operation device 12 provided with the non-contact authentication tag 26 in which the identifier ID1 is recorded, the identifier ID1 acquired by the identifier acquisition unit 27 coincides with the identifier ID1 acquired by the identifier acquisition unit 27 and stored in the storage unit 81 in the setting mode, and thus an operation content for the wireless operation device 11 is validated by the authentication unit 24. Thus, a worker can perform, by using the teaching operation device 1 formed of the wireless operation device 11 and the wired operation device 12, teaching (manual operation) of the robot 2, registration, editing, or condition setting of a motion program related to the robot 2, and the like as a manual operation on the robot 2 using the wireless operation device 11.

On the other hand, when the wireless operation device 11 is attached to the wired operation device 12 provided with the non-contact authentication tag 26 in which an identifier ID2 is recorded, the identifier ID2 acquired by the identifier acquisition unit 27 does not coincide with the identifier ID1 acquired by the identifier acquisition unit 27 and stored in the storage unit 81 in the setting mode, and thus an operation content for the wireless operation device 11 is invalidated by the authentication unit 24. Thus, the worker cannot command a motion of the robot 2 to the controller 3 by using the teaching operation device 1 formed of the wireless operation device 11 and the wired operation device 12.

### Fifth Embodiment

Next, a machine operation system according to a fifth embodiment of the present disclosure will be described.

In the fourth embodiment of the present disclosure described above, an identifier of the non-contact authentication tag 26 acquired in the setting mode is written to the storage unit 81 in the wireless operation device 11, but, in the fifth embodiment of the present disclosure, an identifier of a non-contact authentication tag 26 acquired in a setting mode is written to a storage unit in a controller 3.

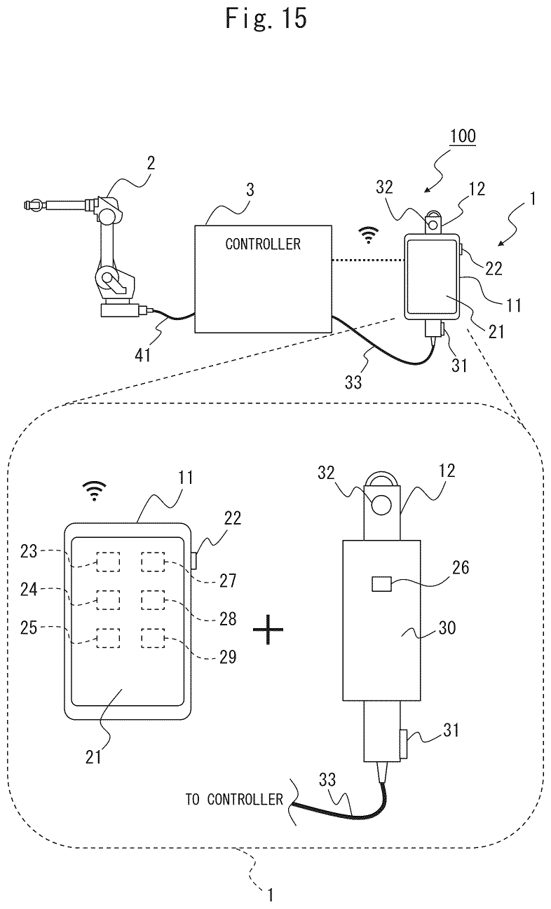

FIG. 15 is a diagram illustrating the machine operation system according to the fifth embodiment of the present disclosure.

As illustrated in FIG. 15, a machine operation system 100 according to the fifth embodiment of the present disclosure further includes an identifier acquisition unit 27, an identifier writing unit 28, and an identifier reading unit 29 in the wireless operation device 11 of the machine operation system 100 illustrated in FIG. 1. A robot 2, the controller 3, a teaching operation device cable 33, and a robot cable 41 are as described with reference to FIG. 1.

An identifier unique to a wired operation device 12 is recorded in the non-contact authentication tag 26 provided in the wired operation device 12. Therefore, when there are a plurality of the wired operation devices 12, an identifier unique to each of the wired operation devices 12 is assigned to the non-contact authentication tag 26 of each of the wired operation devices 12. A configuration of the wired operation device 12 other than the non-contact authentication tag 26 is as described with reference to FIG. 1.

Similarly to the fourth embodiment, the fifth embodiment of the present disclosure also includes a setting mode of pairing a wireless operation device 11 and the wired operation device 12, and a normal operation mode as a teaching operation device 1. The setting mode is performed in advance before the operation mode.

The wireless operation device 11 includes the identifier acquisition unit 27, the identifier writing unit 28, and the identifier reading unit 29 in addition to an event detection unit 23, an authentication unit 24, and an application execution unit 25. FIG. 15 schematically illustrates the event detection unit 23, the authentication unit 24, the application execution unit 25, the identifier acquisition unit 27, the identifier writing unit 28, and the identifier reading unit 29.

The event detection unit 23, the application execution unit 25, a touch panel 21, and a power supply button 22 are as described with reference to FIG. 1.

The identifier acquisition unit 27 acquires an identifier of the non-contact authentication tag 26 when an approach event is detected by the event detection unit 23. In both of the setting mode and the operation mode, identifier acquisition processing may be executed by the identifier acquisition unit 27.

The identifier writing unit 28 writes, as a reference identifier to a storage unit (not illustrated in FIG. 15) of the controller 3, an identifier of the non-contact authentication tag 26 acquired by the identifier acquisition unit 27 in the setting mode. When the reference identifier is written to the storage unit of the controller 3 from the identifier writing unit 28 in the wireless operation device 11, the reference identifier is transmitted from the wireless operation device 11 to the controller 3 via wireless communication. The narrow area wireless communication described already is used as the wireless communication between the wireless operation device 11 and the controller 3.

The identifier reading unit 29 reads the reference identifier from the storage unit of the controller 3 when an approach event is detected in the operation mode after the setting mode. When the reference identifier is read from the storage unit of the controller 3 by the identifier writing unit 28 in the wireless operation device 11, the reference identifier is transmitted from the controller 3 to the wireless operation device 11 via wireless communication. The narrow area wireless communication described already is used as the wireless communication between the controller 3 and the wireless operation device 11.

In the operation mode, the authentication unit 24 validates an operation content for the wireless operation device 11 when an identifier acquired by the identifier acquisition unit 27 coincides with the reference identifier. Further, in the operation mode, the authentication unit 24 invalidates an operation content for the wireless operation device 11 when an identifier acquired by the identifier acquisition unit 27 does not coincide with the reference identifier.

The event detection unit 23, the authentication unit 24, the application execution unit 25, the identifier acquisition unit 27, the identifier writing unit 28, and the identifier reading unit 29 may be constituted in a software program form, for example, or may be constituted by a combination of various electronic circuits and a software program. For example, when the event detection unit 23, the authentication unit 24, the application execution unit 25, the identifier acquisition unit 27, the identifier writing unit 28, and the identifier reading unit 29 are constituted in the software program form, various software programs are installed in the storage unit (not illustrated) in the wireless operation device 11, an arithmetic processing unit (not illustrated) in the wireless operation device 11 performs a motion according to the software program installed in the storage unit, and thus a function of the event detection unit 23, the authentication unit 24, the application execution unit 25, the identifier acquisition unit 27, the identifier writing unit 28, and the identifier reading unit 29 is achieved. Alternatively, the event detection unit 23, the authentication unit 24, the application execution unit 25, the identifier acquisition unit 27, the identifier writing unit 28, and the identifier reading unit 29 may be achieved as a semiconductor integrated circuit to which a software program achieving a function of each of the units is written, and, in this case, the function of the event detection unit 23, the authentication unit 24, the application execution unit 25, the identifier acquisition unit 27, the identifier writing unit 28, and the identifier reading unit 29 is achieved by installing the semiconductor integrated circuit in the wireless operation device 11.

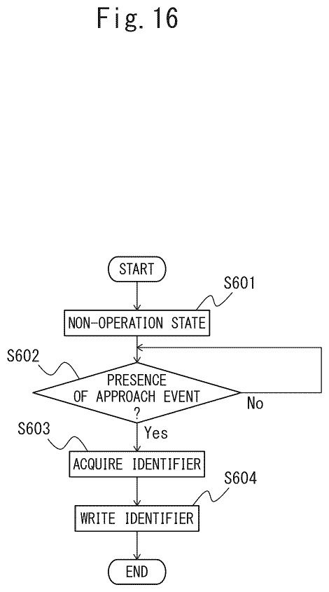

FIG. 16 is a flowchart illustrating a motion flow in the setting mode of the machine operation system according to the fifth embodiment of the present disclosure.

When the wired operation device 12 and the wireless operation device 11 in step S601 are in a non-operation state, the wireless operation device 11 does not command a motion of the robot 2 to the controller 3. In step S601, a worker activates an operation application software program by pressing (touching) an activation icon 51, and a teaching operation screen is displayed on the touch panel 21. Then, the worker activates the setting mode on the operation application software program. The setting mode is activated by pressing (touching), for example, a setting mode activation button of the teaching operation screen.

In step S602, the authentication unit 24 determines whether an approach event is detected by the event detection unit 23. The processing in step S602 is repeatedly executed in a predetermined cycle.

When the worker attaches the wireless operation device 11 to the wired operation device 12, the event detection unit 23 detects the approach event, and thus the authentication unit 24 determines that the approach event is detected by the event detection unit 23 in step S602, and the processing then proceeds to step S603.

In step S603, the identifier acquisition unit 27 acquires an identifier of the non-contact authentication tag 26, and sets the identifier as a reference identifier.

In step S604, the identifier acquisition unit 27 writes the acquired reference identifier of the non-contact authentication tag 26 to the storage unit in the controller 3. When the reference identifier is written to the storage unit of the controller 3 from the identifier writing unit 28 in the wireless operation device 11, the reference identifier is transmitted from the wireless operation device 11 to the controller 3 via wireless communication. In this way, pairing of the wireless operation device 11 and the wired operation device 12 is completed, and thus the setting mode ends.

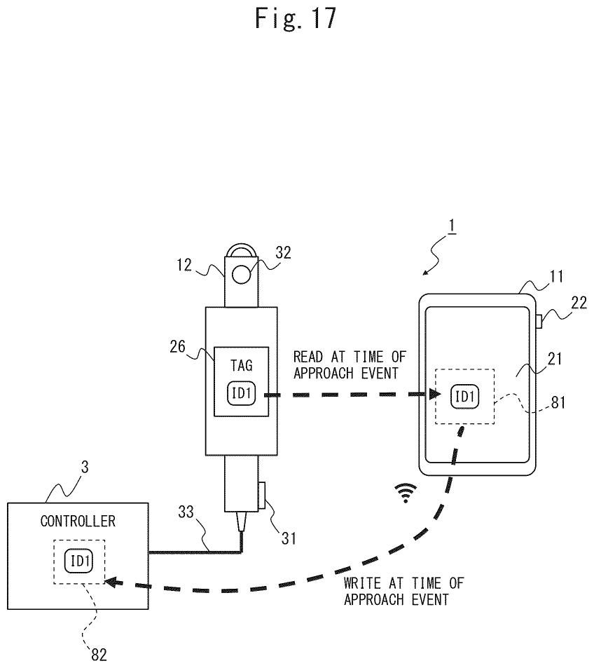

FIG. 17 is a diagram illustrating a specific example of a motion in the setting mode of the machine operation system according to the fifth embodiment of the present disclosure. It should be noted that FIG. 17 illustrates the wireless operation device 11 and the wired operation device 12 being detached from each other for simplifying the description, but it is assumed that the wireless operation device 11 is actually attached to the wired operation device 12.

In FIG. 17, an identifier ID1 unique to the wired operation device 12 provided with the non-contact authentication tag 26 is recorded in the non-contact authentication tag 26. When a worker attaches the wireless operation device 11 to the wired operation device 12, the event detection unit 23 detects an approach event, and thus the authentication unit 24 determines that the approach event is detected by the event detection unit 23. In response to detection of the approach event by the event detection unit 23, the identifier acquisition unit 27 acquires the identifier ID1 of the non-contact authentication tag 26, and writes the identifier ID1 as a reference identifier ID1. The identifier acquisition unit 27 writes the acquired reference identifier of the non-contact authentication tag 26 to a storage unit 82 in the controller 3 via wireless communication. When the reference identifier is written to the storage unit of the controller 3 from the identifier writing unit 28 in the wireless operation device 11, the reference identifier is transmitted from the wireless operation device 11 to the controller 3 via wireless communication. In this way, pairing of the wireless operation device 11 and the wired operation device 12 is completed.

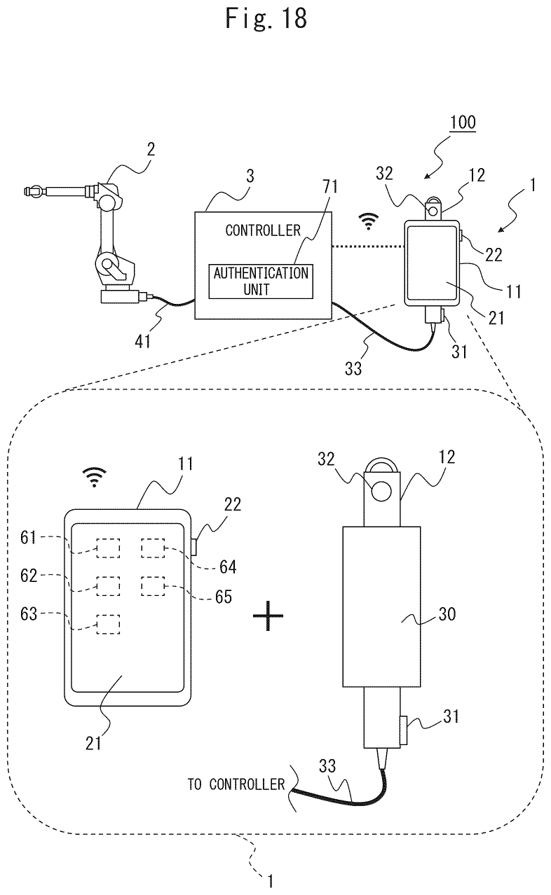

It should be noted that the authentication unit 24 is provided in the wireless operation device 11 in the fifth embodiment of the present disclosure, but an authentication unit may be provided in the controller 3 as a modification example thereof. FIG. 18 is a diagram illustrating a machine operation system according to a modification example of the fifth embodiment of the present disclosure. In the modification example of the fifth embodiment of the present disclosure, an authentication unit 71 is provided in the controller 3. The authentication unit 71 has the same function as that of the authentication unit 24 illustrated in FIG. 15. However, at a time of authentication processing by the authentication unit 71, an identifier acquired by the identifier reading unit 29 in the operation mode is transmitted to the controller 3 via wireless communication. Further, an event detection unit 61, an application execution unit 62, an identifier acquisition unit 63, an identifier writing unit 64, and an identifier reading unit 65 have the same function as that of the event detection unit 23, the application execution unit 25, the identifier acquisition unit 27, the identifier writing unit 28, and the identifier reading unit 29 illustrated in FIG. 15. FIG. 18 schematically illustrates the event detection unit 61, the application execution unit 62, the identifier acquisition unit 63, the identifier writing unit 64, and the identifier reading unit 65.

The event detection unit 61, the application execution unit 62, the identifier acquisition unit 63, the identifier writing unit 64, and the identifier reading unit 65 may be constituted in a software program form, for example, or may be constituted by a combination of various electronic circuits and a software program. For example, when the event detection unit 61, the application execution unit 62, the identifier acquisition unit 63, the identifier writing unit 64, and the identifier reading unit 65 are constituted in the software program form, various software programs are installed in the storage unit (not illustrated) in the wireless operation device 11, an arithmetic processing unit (not illustrated) in the wireless operation device 11 performs a motion according to the software program installed in the storage unit, and thus a function of the event detection unit 61, the application execution unit 62, the identifier acquisition unit 63, the identifier writing unit 64, and the identifier reading unit 65 is achieved. Alternatively, the event detection unit 61, the application execution unit 62, the identifier acquisition unit 63, the identifier writing unit 64, and the identifier reading unit 65 may be achieved as a semiconductor integrated circuit to which a software program achieving a function of each of the units is written, and, in this case, the function of the event detection unit 61, the application execution unit 62, the identifier acquisition unit 63, the identifier writing unit 64, and the identifier reading unit 65 is achieved by installing the semiconductor integrated circuit in the wireless operation device 11.

The authentication unit 71 may be constituted in a software program form, for example, or may be constituted by a combination of various electronic circuits and a software program. For example, when the authentication unit 71 is constituted in the software program form, various software programs are installed in the storage unit (not illustrated) in the controller 3, an arithmetic processing unit (not illustrated) in the controller 3 performs a motion according to the software program installed in the storage unit, and thus a function of the authentication unit 71 is achieved. Alternatively, the authentication unit 71 may be achieved as a semiconductor integrated circuit in which a software program achieving a function of the authentication unit 71 is written, and, in this case, the function of the authentication unit 71 is achieved by installing the semiconductor integrated circuit in the controller 3.

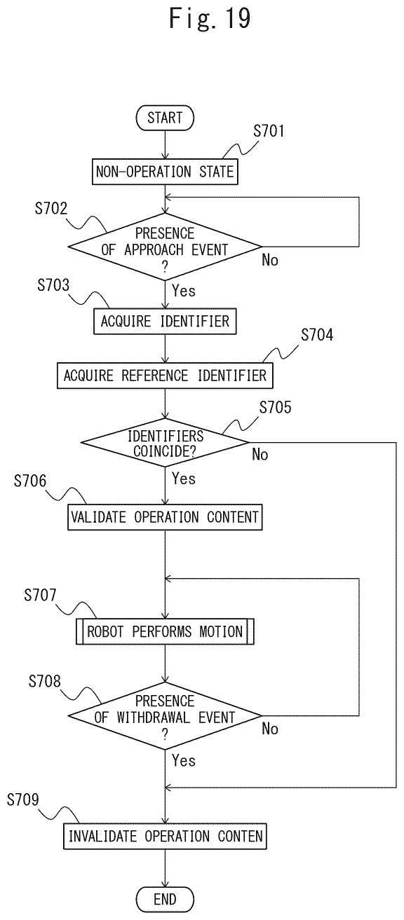

FIG. 19 is a flowchart illustrating a motion flow in the operation mode of the machine operation system according to the fifth embodiment of the present disclosure.

At a stage of step S701, pairing of the wireless operation device 11 and the wired operation device 12 in the setting mode is already completed. A worker activates an operation application software program by pressing (touching) the activation icon 51, and displays a teaching operation screen on the touch panel 21. Then, the worker activates the operation mode on the operation application software program. The operation mode is activated by, for example, pressing (touching) an operation mode activation button of the teaching operation screen. When the wired operation device 12 and the wireless operation device 11 in step S701 are in a non-operation state, the wireless operation device 11 does not command a motion of the robot 2 to the controller 3.

In step S702, the authentication unit 24 determines whether an approach event is detected by the event detection unit 23. The processing in step S702 is repeatedly executed in a predetermined cycle.

When the worker attaches the wireless operation device 11 to the wired operation device 12, the event detection unit 23 detects the approach event, and thus the authentication unit 24 determines that the approach event is detected by the event detection unit 23 in step S702, and the processing then proceeds to step S703.

In step S703, the identifier acquisition unit 27 acquires an identifier of the non-contact authentication tag 26.

In step S704, the identifier reading unit 29 reads a reference identifier from the storage unit of the controller 3 via wireless communication.

In step S705, the authentication unit 24 determines whether the identifier acquired by the identifier acquisition unit 27 in step S703 coincides with the reference identifier read by the identifier reading unit 29 in step S704.

When it is determined that the identifier acquired by the identifier acquisition unit 27 coincides with the reference identifier in step S705, the authentication unit 24 validates an operation content for the wireless operation device 11 in step S706. In this way, the worker can perform teaching (manual operation) of the robot 2, registration, editing, or condition setting of a motion program related to the robot 2, and the like as a manual operation on the robot 2 using the wireless operation device 11. In response to the manual operation of the wireless operation device 11 by the worker, the controller 3 controls a motion of the robot 2 (step S707). It should be noted that, in the processing in step S707, an operation of the robot 2 via the wireless operation device 11 can be achieved while an enable switch 31 is pressed, and the robot 2 makes an emergency stop when an emergency stop button 32 is pressed.

In step S708, the authentication unit 24 determines whether a withdrawal event is detected by the event detection unit 23. The processing in step S708 is repeatedly executed in a predetermined cycle.

When the withdrawal event is not detected in step S708, the processing returns to step S707.

When the withdrawal event is detected in step S708, the authentication unit 24 invalidates an operation content for the wireless operation device 11 in step S709. In this way, the worker cannot command a motion of the robot 2 to the controller 3 by using the teaching operation device 1 formed of the wireless operation device 11 and the wired operation device 12.

Further, when it is not determined that the identifier acquired by the identifier acquisition unit 27 coincides with the reference identifier in step S705, the authentication unit 24 also invalidates an operation content for the wireless operation device 11 in step S709. In this way, the worker cannot command a motion of the robot 2 to the controller 3 by using the teaching operation device 1 formed of the wireless operation device 11 and the wired operation device 12.

It should be noted that, each step described above can be achieved in a form of a software program (computer program) that can be executed by the arithmetic processing device in the wireless operation device 11. Creating a device that executes the processing described above and the software program that causes a computer to execute the processing described above is a matter that can be easily performed by a person skilled in the art. Further, storing, in a recording medium, a computer program that causes a computer to execute the processing described above is also obvious to the person skilled in the art.

The computer program for causing a computer (the arithmetic processing device in the wireless operation device 11) to execute authentication processing in the machine operation system 100 according to the fifth embodiment of the present disclosure includes an event detection step, an authentication step, an application execution step, an identifier acquisition step, an identifier writing step, and an identifier reading step. In the event detection step, an approach event in which the non-contact authentication tag 26 enters the inside of a predefined first region of the wireless operation device 11 from the outside of the first region, and a withdrawal event in which the non-contact authentication tag 26 exits the inside of the first region to the outside of the first region are detected. In the application execution step, an operation application software program that controls the controller 3 in such a way that the robot 2 performs a motion in response to an operation content related to a teaching operation on the robot 2 is executed. In the identifier acquisition step, an identifier unique to the wired operation device 12 of the non-contact authentication tag 26 is acquired when the approach event is detected in the event detection step. In the identifier writing step, the identifier of the non-contact authentication tag 26 acquired in the identifier acquisition step in the setting mode is written as a reference identifier to the storage unit of the controller 3 via wireless communication. In the identifier reading step, the reference identifier is read from the storage unit of the controller 3 via wireless communication when the approach event is detected in the event detection step in the operation mode. In the authentication step, in the operation mode, an operation content for the wireless operation device 11 is validated when the identifier acquired in the identifier acquisition step coincides with the reference identifier acquired in the identifier reading step, and an operation content for the wireless operation device 11 is validated when the identifier acquired in the identifier acquisition step does not coincide with the reference identifier acquired in the identifier reading step.

Further, the computer program for causing a computer (the arithmetic processing device in the wireless operation device 11 or the arithmetic processing device in the controller 3) to execute authentication processing in the machine operation system 100 according to the modification example of the fifth embodiment of the present disclosure includes an event detection step, an authentication step, an application execution step, an identifier acquisition step, an identifier writing step, and an identifier reading step. In the event detection step, an approach event in which the non-contact authentication tag 26 enters the inside of a predefined first region of the wireless operation device 11 from the outside of the first region, and a withdrawal event in which the non-contact authentication tag 26 exits the inside of the first region to the outside of the first region are detected. In the application execution step, an operation application software program that controls the controller 3 in such a way that the robot 2 performs a motion in response to an operation content related to a teaching operation on the robot 2 is executed. In the identifier acquisition step, an identifier unique to the wired operation device 12 of the non-contact authentication tag 26 is acquired when the approach event is detected in the event detection step. In the identifier writing step, the identifier of the non-contact authentication tag 26 acquired in the identifier acquisition step in the setting mode is written as a reference identifier to the storage unit of the controller 3 via wireless communication. In the identifier reading step, the reference identifier is read from the storage unit of the controller 3 via wireless communication when the approach event is detected in the event detection step in the operation mode. In the authentication step, in the operation mode, an operation content for the wireless operation device 11 is validated when the identifier acquired in the identifier acquisition step coincides with the reference identifier acquired in the identifier reading step. Further, in the authentication step, in the operation mode, the controller 3 is caused to execute processing of invalidating an operation content for the wireless operation device 11 when the identifier acquired in the identifier acquisition step does not coincide with the reference identifier acquired in the identifier reading step.

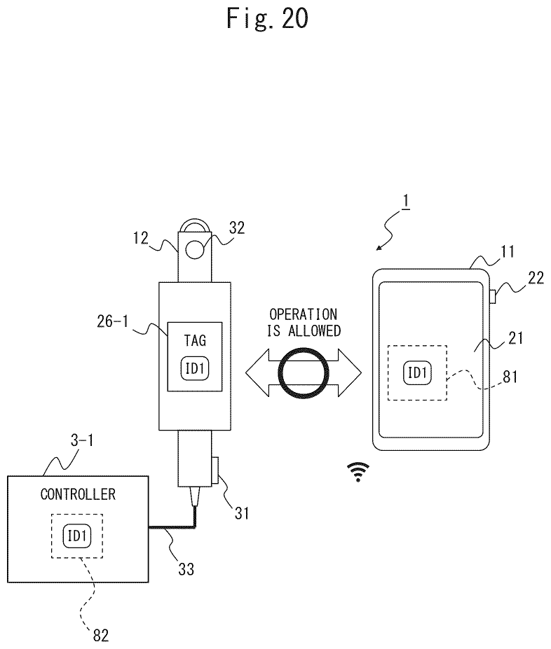

FIG. 20 is a diagram (part 1) illustrating a specific example of a motion in the operation mode of the machine operation system according to the fifth embodiment of the present disclosure.

In FIG. 20, it is assumed that pairing of the wireless operation device 11 and the wired operation device 12 in the setting mode is already completed, and a reference identifier ID1 of the non-contact authentication tag 26 acquired in the setting mode is stored in the storage unit 82 of the controller 3. It should be noted that FIG. 20 illustrates the wireless operation device 11 and the wired operation device 12 being detached from each other for simplifying the description, but it is assumed that the wireless operation device 11 is actually attached to the wired operation device 12.

When the wireless operation device 11 is attached to the wired operation device 12 provided with the non-contact authentication tag 26 in which the reference identifier ID1 is recorded, an identifier ID1 acquired by the identifier acquisition unit 27 coincides with the reference identifier ID1 acquired by the identifier reading unit 29, and thus an operation content for the wireless operation device 11 is validated by the authentication unit 24. Thus, a worker can perform, by using the teaching operation device 1 formed of the wireless operation device 11 and the wired operation device 12, teaching (manual operation) of the robot 2, registration, editing, or condition setting of a motion program related to the robot 2, and the like as a manual operation on the robot 2 using the wireless operation device 11.

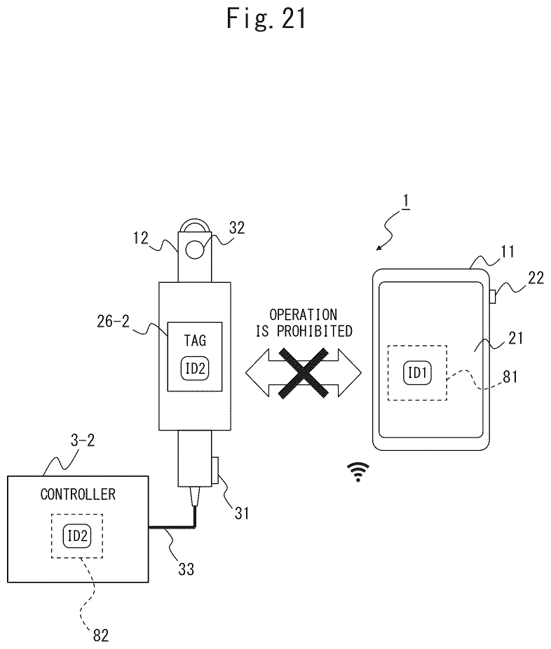

FIG. 21 is a diagram (part 2) illustrating a specific example of a motion in the operation mode of the machine operation system according to the fifth embodiment of the present disclosure.

In FIG. 21, it is assumed that pairing of the wireless operation device 11 and the wired operation device 12 in the setting mode is already completed, and a reference identifier ID2 of the non-contact authentication tag 26 acquired in the setting mode is stored in the storage unit 82 of the controller 3. It should be noted that FIG. 20 illustrates the wireless operation device 11 and the wired operation device 12 being detached from each other for simplifying the description, but it is assumed that the wireless operation device 11 is actually attached to the wired operation device 12.

When the wireless operation device 11 is attached to the wired operation device 12 provided with the non-contact authentication tag 26 in which the reference identifier ID2 is recorded, an identifier ID1 acquired by the identifier acquisition unit 27 does not coincide with the reference identifier ID2 acquired by the identifier reading unit 29, and thus an operation content for the wireless operation device 11 is invalidated by the authentication unit 24. Thus, a worker cannot command a motion of the robot 2 to the controller 3 by using the teaching operation device 1 formed of the wireless operation device 11 and the wired operation device 12.

### Sixth Embodiment

A sixth embodiment includes a tag detection unit configured to detect a non-contact authentication tag 26 instead of the event detection unit 23 in the first embodiment. When the tag detection unit detects the non-contact authentication tag 26 in a first region being a predefined nearby region of a wireless operation device 11, an authentication unit 24 validates an operation content for the wireless operation device 11. The tag detection unit may be constituted in a software program form, for example, or may be constituted by a combination of various electronic circuits and a software program. For example, when the tag detection unit is constituted in the software program form, various software programs are installed in the storage unit (not illustrated) in the wireless operation device 11, an arithmetic processing unit (not illustrated) in the wireless operation device 11 performs a motion according to the software program installed in the storage unit, and thus a function of the tag detection unit is achieved. Alternatively, the tag detection unit may be achieved as a semiconductor integrated circuit in which a software program achieving a function of the tag detection unit is written, and, in this case, the function of the tag detection unit is achieved by installing the semiconductor integrated circuit in the wireless operation device 11.

The computer program for causing a computer (the arithmetic processing device in the wireless operation device 11) to execute authentication processing in a machine operation system 100 according to the sixth embodiment of the present disclosure includes a tag detection step, an authentication step, and an application execution step. In the tag detection step, the non-contact authentication tag 26 is detected. In the authentication step, when the non-contact authentication tag 26 is detected in the tag detection step, an operation content for the wireless operation device 11 is validated. In the application execution step, an operation application software program that controls a controller 3 in such a way that a robot 2 performs a motion in response to an operation content related to a teaching operation on the robot 2 is executed.

### Seventh Embodiment

A seventh embodiment includes a tag detection unit configured to detect a non-contact authentication tag 26 instead of the event detection unit 23 in the fifth embodiment.

When the tag detection unit detects the non-contact authentication tag 26 in a first region being a predefined nearby region of a wireless operation device 11, an identifier acquisition unit 27 acquires an identifier of the non-contact authentication tag 26. In both of a setting mode and an operation mode, identifier acquisition processing may be executed by the identifier acquisition unit 27.

An identifier writing unit 28 writes, as a reference identifier to a storage unit of a controller 3, an identifier of the non-contact authentication tag 26 acquired by the identifier acquisition unit 27 in the setting mode. When the reference identifier is written to the storage unit of the controller 3 from the identifier writing unit 28 in the wireless operation device 11, the reference identifier is transmitted from the wireless operation device 11 to the controller 3 via wireless communication. The narrow area wireless communication described already is used as the wireless communication between the wireless operation device 11 and the controller 3.

An identifier reading unit 29 reads the reference identifier from the storage unit of the controller 3 when the non-contact authentication tag 26 is detected in the operation mode after the setting mode. When the reference identifier is read from the storage unit of the controller 3 by the identifier writing unit 28 in the wireless operation device 11, the reference identifier is transmitted from the controller 3 to the wireless operation device 11 via wireless communication. The narrow area wireless communication described already is used as the wireless communication between the controller 3 and the wireless operation device 11.

In the operation mode, an authentication unit 24 validates an operation content for the wireless operation device 11 when an identifier acquired by the identifier acquisition unit 27 coincides with the reference identifier. Further, in the operation mode, the authentication unit 24 invalidates an operation content for the wireless operation device 11 when an identifier acquired by the identifier acquisition unit 27 does not coincide with the reference identifier.

The tag detection unit, the authentication unit 24, an application execution unit 25, the identifier acquisition unit 27, the identifier writing unit 28, and the identifier reading unit 29 may be constituted in a software program form, for example, or may be constituted by a combination of various electronic circuits and a software program. For example, when the tag detection unit, the authentication unit 24, the application execution unit 25, the identifier acquisition unit 27, the identifier writing unit 28, and the identifier reading unit 29 are constituted in the software program form, various software programs are installed in the storage unit (not illustrated) in the wireless operation device 11, an arithmetic processing unit (not illustrated) in the wireless operation device 11 performs a motion according to the software program installed in the storage unit, and thus a function of the tag detection unit, the authentication unit 24, the application execution unit 25, the identifier acquisition unit 27, the identifier writing unit 28, and the identifier reading unit 29 is achieved. Alternatively, the tag detection unit, the authentication unit 24, the application execution unit 25, the identifier acquisition unit 27, the identifier writing unit 28, and the identifier reading unit 29 may be achieved as a semiconductor integrated circuit to which a software program achieving a function of each of the units is written, and, in this case, the function of the tag detection unit, the authentication unit 24, the application execution unit 25, the identifier acquisition unit 27, the identifier writing unit 28, and the identifier reading unit 29 is achieved by installing the semiconductor integrated circuit in the wireless operation device 11.

The computer program for causing a computer (the arithmetic processing device in the wireless operation device 11) to execute authentication processing in a machine operation system 100 according to the seventh embodiment of the present disclosure includes a tag detection step, an authentication step, an application execution step, an identifier acquisition step, an identifier writing step, and an identifier reading step. In the tag detection step, whether the non-contact authentication tag 26 is present in the predefined first region of the wireless operation device 11 is detected. In the application execution step, an operation application software program that controls the controller 3 in such a way that a robot 2 performs a motion in response to an operation content related to a teaching operation on the robot 2 is executed. In the identifier acquisition step, an identifier unique to a wired operation device 12 of the non-contact authentication tag 26 is acquired when the non-contact authentication tag 26 is detected in the tag detection step. In the identifier writing step, the identifier of the non-contact authentication tag 26 acquired in the identifier acquisition step in the setting mode is written as a reference identifier to the storage unit of the controller 3 via wireless communication. In the identifier reading step, the reference identifier is read from the storage unit of the controller 3 via wireless communication when an approach event is detected in the event detection step in the operation mode. In the authentication step, in the operation mode, an operation content for the wireless operation device 11 is validated when the identifier acquired in the identifier acquisition step coincides with the reference identifier acquired in the identifier reading step, and an operation content for the wireless operation device 11 is invalidated when the identifier acquired in the identifier acquisition step does not coincide with the reference identifier acquired in the identifier reading step.

It should be noted that the first to seventh embodiments (also including the modification examples) described above may be appropriately combined and performed. For example, in a teaching operation screen of an operation application software program, a setting menu screen in which each of the first to seventh embodiments (also including the modification example) can be selected may be provided, and a worker may be able to select a desired embodiment.

Herein, as one example, the case where a machine operated by the machine operation system 100 operates the robot 2 is described above, but the description above can also be similarly applied to a case where a machine operated by the machine operation system 100 is an industrial machine.

According to the first to seventh embodiments of the present disclosure, safety can be secured at a low cost in the machine operation system 100 formed of the wireless operation device 11 being a general-purpose information terminal and the wired operation device 12 being a base member including a safety switch. In the first to seventh embodiments of the present disclosure, an inexpensive non-contact authentication tag 26 can be provided in the wired operation device 12, and the authentication processing can be executed in processing on software, which results in a low cost.

According to the machine operation system 100 in the first to fourth and sixth embodiments of the present disclosure, the wired operation device 12 and the wireless operation device 11 are removably attached, but an operation content for the wireless operation device 11 is not validated unless the wireless operation device 11 is attached to the wired operation device 12. Therefore, a teaching worker can operate a safety switch with his/her own will, which results in a high degree of safety. Further, a possibility that a safety switch is operated by a third person different from the teaching worker can be eliminated, which results in a high degree of safety. Even if the wired operation device 12 and the wireless operation device 11 are detached from each other and located at different places, the teaching worker possesses the wireless operation device 11, and a third person different from the teaching worker possesses the wired operation device 12 and possesses a safety switch, the third person cannot operate the safety switch.

According to the machine operation system 100 in the fifth and seventh embodiments of the present disclosure, an identifier unique to the wired operation device 12 is provided to the non-contact authentication tag 26 provided in the wired operation device 12, and pairing of the wireless operation device 11 and the wired operation device 12 is managed based on the identifier, and thus an operation content for the wireless operation device 11 is not validated even when the wired operation device 12 and the wireless operation device 11 that are not paired are attached to each other via an identifier. Therefore, a teaching worker can operate a safety switch with his/her own will, which results in a high degree of safety. Further, a possibility that a safety switch is operated by a third person different from the teaching worker can be eliminated, which results in a high degree of safety. Even if the wired operation device 12 and the wireless operation device 11 are detached from each other and located at different places, the teaching worker possesses the wireless operation device 11, and a third person different from the teaching worker possesses the wired operation device 12 and possesses a safety switch, the third person cannot operate the safety switch.

Although the embodiments of the present disclosure have been described above in detail, the present disclosure is not limited to the individual embodiments described above. Various types of addition, replacement, modification, partial deletion, and the like may be made to the embodiments without departing from the purpose of the invention or without departing from the contents described in the claims and the scope of the present invention derived from equivalents thereof. For example, in the embodiments described above, an order of operations and an order of pieces of processing are indicated as one example, which is not limited thereto. Further, the same also applies to a case where a numerical value or a numerical expression is used in the description of the embodiments described above.

### Reference Signs List

1 Teaching operation device
2 Robot
3 Controller
11 Wireless operation device
12 Wired operation device
21 Touch panel
22 Power supply button
23 Event detection unit
24 Authentication unit
25 Application execution unit
26 Non-contact authentication tag
27 Identifier acquisition unit
28 Identifier writing unit
29 Identifier reading unit
30 Attachment base
31 Enable switch
32 Emergency stop button
33 Teaching operation device cable
41 Robot cable
51 Activation icon
61 Event detection unit
62 Application execution unit
63 Identifier acquisition unit
64 Identifier writing unit
65 Identifier reading unit
71 Authentication unit
81 Storage unit
82 Storage unit
71 Authentication unit
100 Machine operation system

1. A machine operation system comprising:
a wireless operation device that is connected to a controller of a robot or an industrial machine via wireless communication, and commands a motion of the robot or the industrial machine to the controller in response to an operation content; and
a wired operation device that is connected to the controller via wired communication, and includes a non-contact authentication tag, wherein
the wireless operation device includes
an event detection unit configured to detect an approach event in which the non-contact authentication tag enters the inside of a first region, which is defined to perform wireless communication with the non-contact authentication tag, from the outside of the first region, and a withdrawal event in which the non-contact authentication tag exits the inside of the first region to the outside of the first region, and
an authentication unit configured to determine whether an operation content for the wireless operation device is valid or invalid in response to a content of an event detected by the event detection unit.

2. The machine operation system according to claim 1, wherein
the authentication unit validates an operation content for the wireless operation device when the approach event is detected by the event detection unit, and invalidates an operation content for the wireless operation device when the withdrawal event is detected by the event detection unit.

3. The machine operation system according to claim 1, wherein
the wireless operation device includes an application execution unit configured to execute an operation application software program that controls the controller in such a way that the robot or the industrial machine performs a motion in response to an operation content related to a teaching operation on the robot or the industrial machine.

4. The machine operation system according to claim 3, wherein
event detection processing by the event detection unit is executed when the operation application software program is executed by the application execution unit.

5. The machine operation system according to claim 4, wherein
the application execution unit
activates the operation application software program when power of the wireless operation device is turned on, and
executes the operation application software program as a background process until there is a teaching operation start command to the wireless operation device after activation of the operation application software program, and executes the operation application software program as a foreground process after there is the teaching operation start command.

6. The machine operation system according to claim 5, wherein
after there is a teaching operation end command to the wireless operation device while the operation application software program is executed as a foreground process, the application execution unit executes the operation application software program as a background process.

7. The machine operation system according to claim 3, wherein
the application execution unit executes the operation application software program as a foreground process when the approach event is detected by the event detection unit while the operation application software program is executed as a background process, and the application execution unit executes the operation application software program as a background process when the withdrawal event is detected by the event detection unit while the operation application software program is executed as a foreground process.

8. The machine operation system according to claim 1, wherein
the non-contact authentication tag includes an identifier unique to the wired operation device,
the wireless operation device includes an identifier acquisition unit configured to acquire the identifier of the non-contact authentication tag when the approach event is detected by the event detection unit, and,
in an operation mode, the authentication unit validates an operation content for the wireless operation device when the identifier acquired by the identifier acquisition unit coincides with the identifier acquired in advance by the identifier acquisition unit in a setting mode before the operation mode, and the authentication unit invalidates an operation content for the wireless operation device when the identifier acquired by the identifier acquisition unit does not coincide with the identifier acquired in advance by the identifier acquisition unit in the setting mode.

9. The machine operation system according to claim 1, wherein
the non-contact authentication tag includes an identifier unique to the wired operation device,
the wireless operation device includes an identifier acquisition unit configured to acquire the identifier of the non-contact authentication tag when the approach event is detected by the event detection unit, an identifier writing unit configured to set, as a reference identifier, the identifier of the non-contact authentication tag acquired by the identifier acquisition unit in a setting mode, and write the reference identifier to a storage unit of the controller via wireless communication, and an identifier reading unit configured to read the reference identifier from the storage unit of the controller via wireless communication when the approach event is detected by the event detection unit in an operation mode after the setting mode, and,
in the operation mode, the authentication unit validates an operation content for the wireless operation device when the identifier acquired by the identifier acquisition unit coincides with the reference identifier, and the authentication unit invalidates an operation content for the wireless operation device when the identifier acquired by the identifier acquisition unit does not coincide with the reference identifier.

10. A machine operation system comprising:
a controller of a robot or an industrial machine;
a wireless operation device that is connected to the controller via wireless communication, and commands a motion of the robot or the industrial machine to the controller in response to an operation content; and
a wired operation device that is connected to the controller via wired communication, and includes a non-contact authentication tag to which an individual identifier is assigned, wherein
the wireless operation device includes
an event detection unit configured to detect an approach event in which the non-contact authentication tag enters the inside of a first region, which is defined to perform wireless communication with the non-contact authentication tag, from the outside of the first region,
an identifier acquisition unit configured to acquire the identifier of the non-contact authentication tag when the approach event is detected by the event detection unit, and
an identifier writing unit configured to set, as a reference identifier, the identifier of the non-contact authentication tag acquired by the identifier acquisition unit in a setting mode, and write the reference identifier to a storage unit of the controller via wireless communication.

11. The machine operation system according to claim 10, wherein
the wireless operation device includes an identifier reading unit configured to read the reference identifier from the storage unit of the controller via wireless communication when the approach event is detected by the event detection unit in an operation mode after the setting mode, and
the controller includes an authentication unit configured to, in the operation mode, validate an operation content for the wireless operation device when the identifier acquired by the identifier acquisition unit coincides with the reference identifier, and invalidate
an operation content for the wireless operation device when the identifier acquired by the identifier acquisition unit does not coincide with the reference identifier.

12. The machine operation system according to claim 10, wherein
the event detection unit detects the approach event and a withdrawal event in which the non-contact authentication tag exits the inside of the first region to the outside of the first region.

13. A non-transitory computer readable medium storing a computer program for causing a computer to execute authentication processing in a machine operation system including a wireless operation device that is connected to a controller of a robot or an industrial machine via wireless communication, and commands a motion of the robot or the industrial machine to the controller in response to an operation content, and a wired operation device that is connected to the controller via wired communication, and includes a non-contact authentication tag, the computer program for causing a computer to execute authentication processing comprising:
an event detection step of detecting an approach event in which the non-contact authentication tag enters the inside of a first region, which is defined to perform wireless communication with the non-contact authentication tag, from the outside of the first region, and a withdrawal event in which the non-contact authentication tag exits the inside of the first region to the outside of the first region; and
an authentication step of determining whether an operation content for the wireless operation device is valid or invalid in response to a content of an event detected in the event detection step.

14-30. (canceled)

31. A controller comprising:
at least one memory; and
at least one processor, wherein
the at least one processor
accepts connection with a wireless operation device that can transmit a command related to a motion of a robot or an industrial machine,
accepts connection with a wired operation device including a non-contact authentication tag,
acquires the command related to the motion, based on occurrence of an approach event in which the non-contact authentication tag enters the inside of a first region of the wireless operation device, which is defined to perform wireless communication with the non-contact authentication tag, from the outside of the first region, and
does not acquire the command related to the motion, based on occurrence of a withdrawal event in which the non-contact authentication tag exits the inside of the first region to the outside of the first region.

32. The controller according to claim 31, wherein
information about authentication of an operation content by the wireless operation device is acquired based on the approach event and the withdrawal event.

33. The controller according to claim 31, wherein
the information about the authentication is output from the wireless operation device.

34. The controller according to claim 31, wherein
the at least one processor derives the information about the authentication.

35. The controller according to claim 31, wherein
the information about the authentication is derived based on an execution situation of an operation application software program of the wireless operation device for outputting the command related to the motion.

36. The controller according to claim 31, wherein
the non-contact authentication tag includes an identifier unique to the wired operation device, and
the information about the authentication is derived based on whether the wireless operation device has communicated with the identifier at the approach event.

37. The controller according to claim 36, wherein
the at least one memory stores a reference identifier, and
the information about the authentication is derived based on whether the identifier coincides with the reference identifier.

38. A non-transitory computer readable medium storing a computer program for causing a computer to execute authentication processing of a wireless operation device that can transmit a command related to a motion of a robot or an industrial machine, the computer program comprising:
a step of accepting connection with the wireless operation device;
a step of accepting connection with a wired operation device including a non-contact authentication tag;
a step of acquiring the command related to the motion, based on occurrence of an approach event in which the non-contact authentication tag enters the inside of a first region of the wireless operation device, which is defined to perform wireless communication with the non-contact authentication tag, from the outside of the first region; and
a step of not acquiring the command related to the motion, based on occurrence of a withdrawal event in which the non-contact authentication tag exits the inside of the first region to the outside of the first region.
